(19) United States
(12) Patent Application Publication
(10) Pub. No.: US 2025/0140185 A1
(43) Pub. Date: May 1, 2025

(54) Light Emitting Display Apparatus

(71) Applicant: LG Display Co., Ltd., Seoul (KR)

(72) Inventors: EuiTae Kim, Paju-si (KR); Namwook Cho, Paju-si (KR); Hongsik Kim, Paju-si (KR)

(21) Appl. No.: 18/749,511

(22) Filed: Jun. 20, 2024

(30) Foreign Application Priority Data
Oct. 26, 2023 (KR) 10-2023-0144919

(51) Int. Cl. G09G 3/3233

(52) U.S. Cl. CPC G09G 3/3233; G09G 2300/0819; G09G 2300/0842; G09G 2300/0861; G09G 2320/068; G09G 2380/10

(57) ABSTRACT

The light emitting display apparatus includes a viewing angle control line unit including at least one viewing angle control line between a first unit pixel driving circuit and a second unit pixel driving circuit provided along a nth scan line, and a gate control line unit including gate control lines provided between a kth unit pixel driving circuit and a k+1th unit pixel driving circuit provided along the nth scan line, wherein at least one unit pixel driving circuit is provided between the viewing angle control line unit and the gate control line unit adjacent to each other, the at least one viewing angle control line is connected to the first unit pixel driving circuit and the second unit pixel driving circuit, and the gate control lines are connected to a gate driver provided between the viewing angle control line unit and the gate control line unit.

### CROSS-REFERENCE TO RELATED APPLICATION

This application claims the benefit of the Republic of Korea Patent Application No. 10-2023-0144919 filed on Oct. 26, 2023, which is hereby incorporated by reference in its entirety.

### BACKGROUND

### Field of Technology

The present disclosure relates to a light emitting display apparatus.

### Discussion of the Related Art

A plurality of light emitting display apparatuses for providing information or contents to a driver and a passenger can be mounted on a vehicle.

Among light emitting display apparatuses mounted on a vehicle, light emitting display apparatus mounted on a dashboard is becoming increasingly larger.

However, because a viewing angle of a light emitting display apparatus mounted on a dashboard is fixed, drivers and passengers may feel uncomfortable watching videos.

Moreover, because a gate driver is provided in a non-display area of a light emitting display apparatus having a large left-right width, image quality degradation may occur due to delays in gate pulses.

### SUMMARY

Accordingly, the present disclosure is directed to providing a light emitting display apparatus that substantially obviates one or more problems due to limitations and disadvantages of the related art.

An aspect of the present disclosure is directed to providing a light emitting display apparatus in which a viewing angle can be controlled and a gate driver is provided in a display area.

Additional advantages and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description as well as the appended drawings.

To achieve these and other advantages and in accordance with the purpose of the disclosure, as embodied and broadly described herein, there is provided a light emitting display apparatus comprising a viewing angle control line unit including at least one viewing angle control line provided between a first unit pixel driving circuit and a second unit pixel driving circuit provided along a nth (n is a natural number) scan line, and a gate control line unit including gate control lines provided between a kth (k is a natural number) unit pixel driving circuit and a k+1th unit pixel driving circuit provided along the nth scan line, wherein at least one unit pixel driving circuit is provided between the viewing angle control line unit and the gate control line unit adjacent to each other, the at least one viewing angle control line is connected to the first unit pixel driving circuit and the second unit pixel driving circuit, and the gate control lines are connected to a gate driver provided between the viewing angle control line unit and the gate control line unit.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is an exemplary diagram illustrating a configuration of a light emitting display apparatus according to an embodiment of the present disclosure;

FIG. 2 is an exemplary diagram illustrating a structure of a subpixel applied to a light emitting display apparatus according to an embodiment of the present disclosure;

FIG. 3 is an exemplary diagram illustrating a structure of a control driver applied to a light emitting display apparatus according to an embodiment of the present disclosure;

FIGS. 4A, 4B and 4C are exemplary diagrams illustrating a structure of a gate driver applied to a light emitting display apparatus according to an embodiment of the present disclosure;

FIG. 5 is an exemplary diagram illustrating a structure of a data driver applied to a light emitting display apparatus according to an embodiment of the present disclosure;

FIG. 6 is an exemplary diagram illustrating an internal structure of a vehicle to which a light emitting display apparatus according to an embodiment of the present disclosure is applied;

FIGS. 7A to 7C are exemplary diagrams illustrating how viewing angles of light emitting areas change in a light emitting display panel according to an embodiment of the present disclosure;

FIG. 8 is an exemplary plan view schematically illustrating a structure of a subpixel of a light emitting display panel according to an embodiment of the present disclosure;

FIGS. 9A and 9B are exemplary perspective views illustrating structures of a first lens and a second lens of a subpixel applied to a light emitting display panel according to an embodiment of the present disclosure;

FIG. 10 is an exemplary plan view illustrating a structure of three subpixels applied to a light emitting display panel according to an embodiment of the present disclosure;

FIG. 11 is an exemplary cross-sectional surface taken along line I-I′ illustrated in FIG. 10 according to an embodiment of the present disclosure;

FIG. 12 is an exemplary cross-sectional surface taken along line II-II′ illustrate in FIG. 10 according to an embodiment of the present disclosure;

FIG. 13 is an exemplary timing diagram for explaining a basic driving method of a light emitting display apparatus according to an embodiment of the present disclosure;

FIG. 14 is an exemplary diagram illustrating an area A illustrated in FIG. 1 according to an embodiment of the present disclosure;

FIG. 15 is an exemplary diagram illustrating a light emitting display panel applied to a light emitting display apparatus according to the present disclosure;

FIG. 16 is an exemplary diagram illustrating a configuration of a scan stage applied to a light emitting display apparatus according to an embodiment of the present disclosure;

FIG. 17 is an exemplary diagram illustrating a configuration of an emission stage applied to a light emitting display apparatus according to an embodiment of the present disclosure;

FIG. 18 is an exemplary diagram illustrating an area B illustrated in FIG. 1 according to an embodiment of the present disclosure;

FIG. 19 is an exemplary diagram illustrating an area C illustrated in FIG. 18 according to an embodiment of the present disclosure;

FIG. 20 is an exemplary diagram illustrating a cross-sectional surface of a light emitting display panel applied to a light emitting display apparatus according to an embodiment of the present disclosure;

FIG. 21 is an exemplary diagram illustrating a cross-sectional surface taken along line V-V′ illustrated in FIG. 19 according to an embodiment of the present disclosure; and

FIG. 22 is an exemplary diagram illustrating a cross-sectional surface taken along a line W-W′ illustrated in FIG. 19 according to an embodiment of the present disclosure.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. When “comprise,” “have,” and “include” described in the present specification are used, another part may be added unless “only” is used. The terms of a singular form may include plural forms unless referred to the contrary.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts may be disposed between the two parts unless a more limiting term, such as “just” or “direct(ly)” is used.

In describing a time relationship, for example, when the temporal order is described as, for example, “after,” “subsequent,” “next,” and “before,” a case that is not continuous may be included unless a more limiting term, such as “just,” “immediate(ly),” or “direct(ly)” is used.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc. may be used. These terms are intended to identify the corresponding elements from the other elements, and basis, order, or number of the corresponding elements should not be limited by these terms. The expression that an element is “connected,” “coupled,” or “adhered” to another element or layer the element or layer can not only be directly connected or adhered to another element or layer, but also be indirectly connected or adhered to another element or layer with one or more intervening elements or layers “disposed,” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

Features of various embodiments of the present disclosure may be partially or overall coupled to or combined with each other, and may be variously inter-operated with each other and driven technically as those skilled in the art can sufficiently understand. The embodiments of the present disclosure may be carried out independently from each other, or may be carried out together in co-dependent relationship.

Hereinafter, embodiments of the present disclosure will be described in detail with reference to the accompanying drawings.

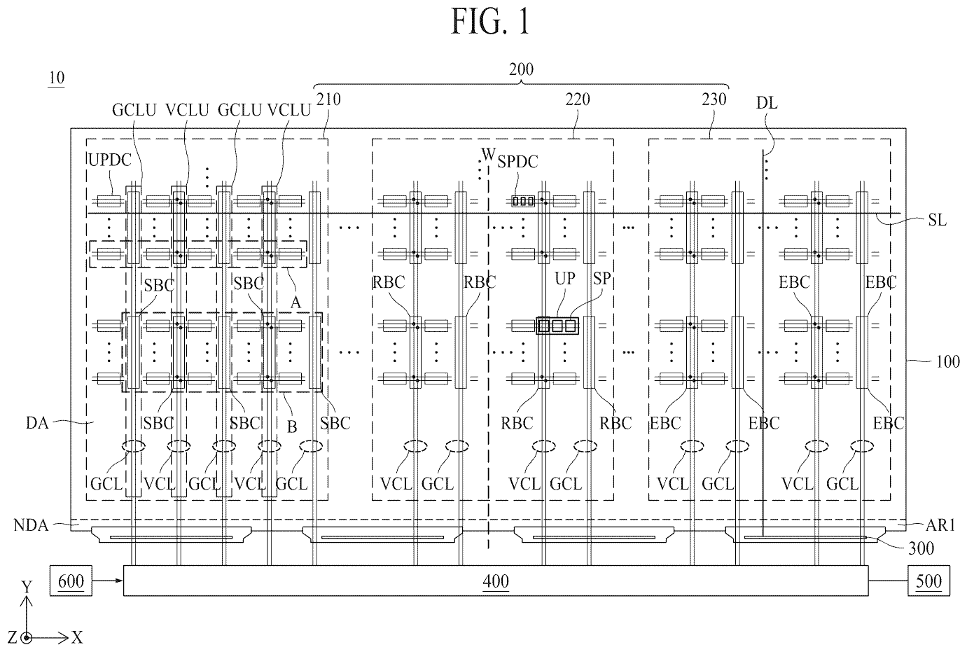

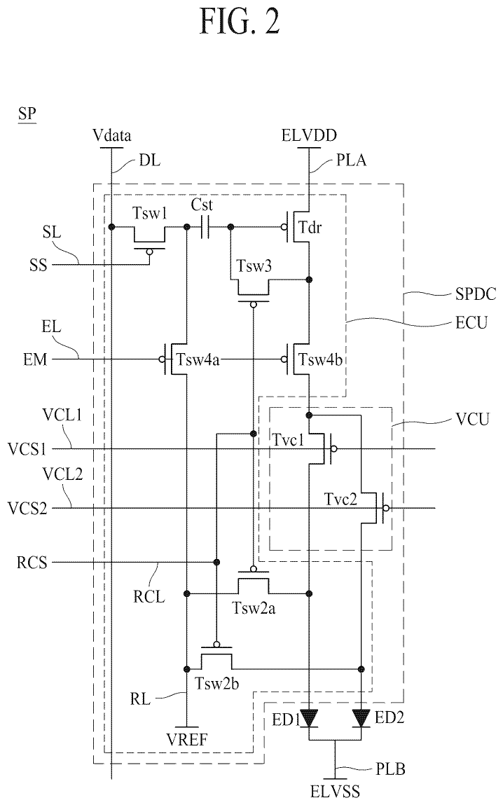

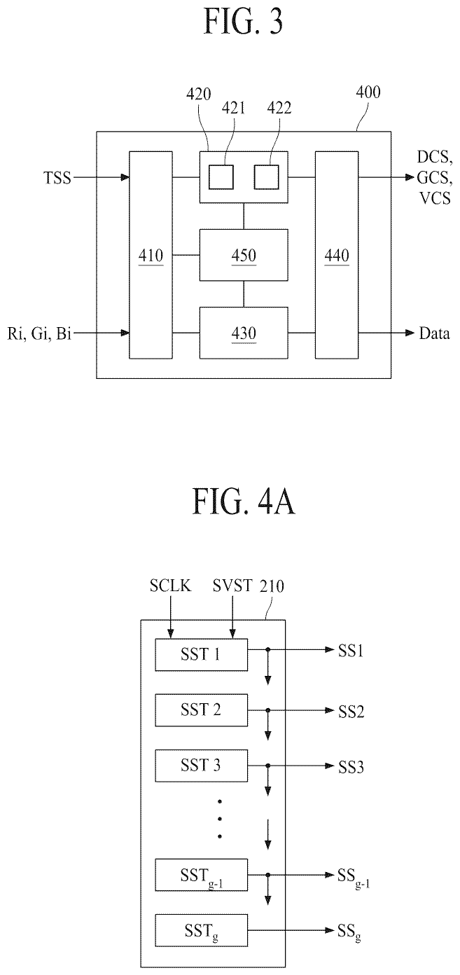

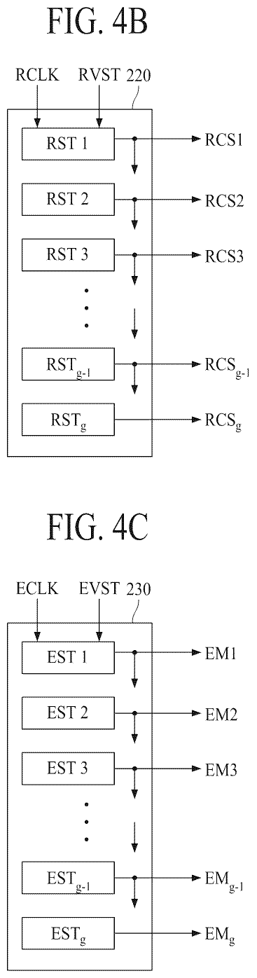

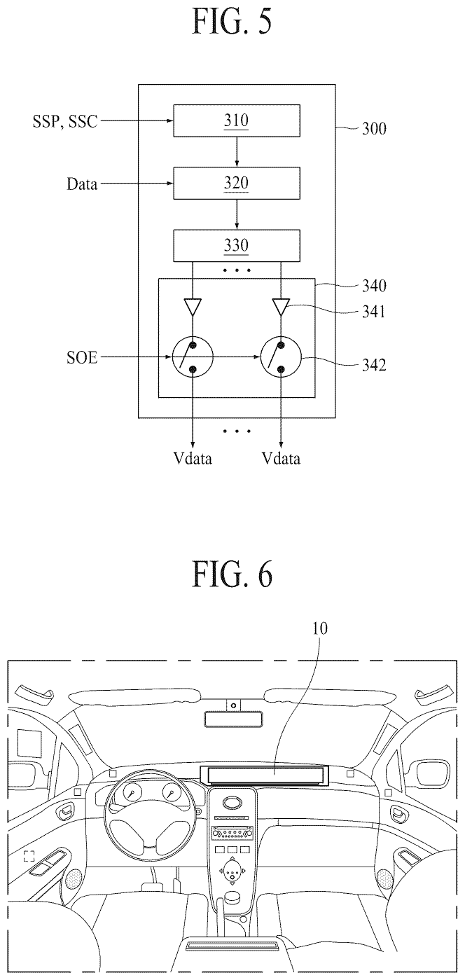

FIG. 1 is an exemplary diagram illustrating a configuration of a light emitting display apparatus according to an embodiment of the present disclosure, FIG. 2 is an exemplary diagram illustrating a structure of a subpixel applied to a light emitting display apparatus according to an embodiment of the present disclosure, FIG. 3 is an exemplary diagram illustrating a structure of a control driver applied to a light emitting display apparatus according to an embodiment of the present disclosure, FIGS. 4A, 4B and 4C are exemplary diagrams illustrating a structure of a gate driver applied to a light emitting display apparatus according to an embodiment of the present disclosure, and FIG. 5 is an exemplary diagram illustrating a structure of a data driver applied to a light emitting display apparatus according to an embodiment of the present disclosure.

A light emitting display apparatus according to an embodiment of the present disclosure may be any one of an organic light emitting diode display apparatus, a quantum dot light emitting diode display apparatus, and an inorganic light emitting diode display apparatus. That is, a light emitting display apparatus according to an embodiment of the present disclosure may be an electroluminescent display apparatus. Moreover, a light emitting display apparatus according to an embodiment of the present disclosure may be a micro light emitting diode display apparatus.

A light emitting display apparatus according to an embodiment of the present disclosure can be used as various kinds of electronic devices. Electronic devices can be, for example, televisions, monitors, etc., and can be automotive electronic devices mounted and used in vehicle. Particularly, a light emitting display apparatus according to an embodiment of the present disclosure can be mounted on a dashboard of a vehicle to provide information and various images related to an operation of the vehicle to a driver and a passenger. Hereinafter, for convenience of description, a light emitting display apparatus mounted on a dashboard of a vehicle to be used will be described as an example of a light emitting display apparatus according to an embodiment of the present disclosure.

The light emitting display apparatus according to an embodiment of the present disclosure, as illustrated in FIGS. 1 and 2, can include a light emitting display panel 100 which includes a display area DA displaying an image and a non-display area NDA provided outside the display area DA, a gate driver 200 which is provided in the display area DA and supplies gate signals GS to a plurality of gate lines GL1 to GLg provided in the display area DA of the display panel 100, a data driver 300 which supplies data voltages Vdata to a plurality of data lines DL1 to DLd provided in the display area DA of the display panel 100, a control driver 400 which controls driving of the gate driver 200 and the data driver 300, and a power supply unit 500 which supplies power to the control driver 400, the gate driver 200, the data driver 300, and the light emitting display panel 100.

First, the light emitting display panel 100 can include a display area DA and a non-display area NDA. Gate lines, data lines, and subpixels SP can be provided in the display area DA. Accordingly, an image can be displayed in the display area DA.

The gate lines can include a scan line SL, a reference control line RCL, and an emission line EL as illustrated in FIG. 2. In the following description, the number of the scan lines SL is g (g is a natural number). In this case, each of the number of the reference control lines RCL and the number of the emission lines EL may also be g.

The non-display area NDA can surround the outside of the display area DA.

However, in a light emitting display apparatus according to the present disclosure, because the gate driver 200 connected to the gate lines is provided in the display area DA, the width of the non-display area NDA can be reduced, or there may be almost no non-display area NDA. For example, as illustrated in FIG. 1, when the gate driver 200 connected to the scan lines SL is provided in the display area DA, a flexible film provided with the data driver 300 is connected to a first area AR1 of the light emitting display panel 100, and the control driver 400 is connected to the light emitting display panel 100 through the first area AR1, the non-display area NDA can be provided only in the first area AR1 among the four areas provided outside the light emitting display panel 100. In this case, the non-display area NDA may not be provided in the remaining three areas, or the non-display area NDA having a very small width may be provided in the remaining three areas.

Also, when pads connected to the data driver 300 and the control driver 400 extend to a rear surface of the light emitting display panel 100 through a first side adjacent to the first area AR1, there may be no non-display area NDA in the four areas of the light emitting display panel 100, or a non-display area NDA having a very small width may be provided in the four areas.

The subpixel SP included in the light emitting display panel 100, as illustrated in FIG. 2, can include a subpixel driving circuit SPDC which includes a switching transistor Tsw1, a storage capacitor Cst, a driving transistor Tdr, a first reference transistor Tsw2a, a second reference transistor Tsw2b, a first viewing angle control transistor Tvc1, and a second viewing angle control transistor Tvc2, and a first light emitting device ED1 and a second light emitting device ED2 which are connected to the subpixel driving circuit PDC. That is, the subpixel SP can include the subpixel driving circuit, the first light emitting device ED1 and the second light emitting device ED2.

A first terminal of the driving transistor Tdr can be connected to a first voltage supply line through which a first voltage EVDD is supplied, and a second terminal of the driving transistor Tdr can be connected to the light emitting device ED.

A first terminal of the switching transistor Tsw1 can be connected to a data line DL, a second terminal of the switching transistor Tsw1 can be connected to a first terminal of the storage capacitor Cst, and a gate of the switching transistor Tsw1 can be connected to a scan line SL.

A data voltage Vdata can be supplied through the data line DL from the data driver 300. A scan signal SS can be supplied through the scan line SL from the gate driver 200. The scan signal SS can include a scan pulse GP for turning on the switching transistor Tsw1 and a scan-off signal for turning off the switching transistor Tsw1.

The first reference transistor Tsw2a and the second reference transistor Tsw2b can be provided for measuring a threshold voltage of the driving transistor Tdr or mobility, or supplying a reference voltage VREF to the subpixel driving circuit SPDC.

A first terminal of the first reference transistor Tsw2a can be connected to a reference line RL through which a reference voltage VREF is supplied, a second terminal of the first reference transistor Tsw2a can be connected to a second terminal of the first viewing angle control transistor Tvc1 and the first light emitting device ED1, and a gate of the first reference transistor Tsw2a can be connected to a reference control line RCL through which a reference control signal RCS is supplied.

A first terminal of the second reference transistor Tsw2b can be connected to a reference line RL through which the reference voltage VREF is supplied, a second terminal of the second reference transistor Tsw2b can be connected to a second terminal of the second viewing angle control transistor Tvc2 and the second light emitting device ED2, and a gate of the second reference transistor Tsw2b can be connected to the reference control line RCL through which the reference control signal RCS is supplied.

The reference line RL can be connected to the data driver 300 and can be connected to the power supply unit 500 through the data driver 300. For example, the reference voltage VREF supplied from the power supply unit 500 can be supplied to the subpixels SP through the reference line RL, sensing signals transmitted from the subpixels SP can be converted into digital sensing signals in the data driver 300, and the digital sensing signals can be transmitted to the control driver 400.

A first terminal of the storage capacitor Cst can be connected to a second terminal of the switching transistor Tsw1, and a second terminal of the storage capacitor Cst can be connected to a gate of the driving transistor Tdr.

A first terminal of the first viewing angle control transistor Tvc1 can be connected to the second terminal of the driving transistor Tdr, a second terminal of the first viewing angle control transistor Tvc1 can be connected to the first light emitting device ED1, and a gate of the first viewing angle control transistor Tvc1 can be connected to a first viewing angle control line VCL1.

A first terminal of the second viewing angle control transistor Tvc2 can be connected to the second terminal of the driving transistor Tdr, a second terminal of the second viewing angle control transistor Tvc2 can be connected to the second light emitting device ED2, and a gate of the second viewing angle control transistor Tvc2 can be connected to a second viewing angle control line VCL2.

That is, the gate of the first viewing angle control transistor Tvc1 can be connected to the first viewing angle control line VCL1 and the gate of the second viewing angle control transistor Tvc2 can be connected to the second viewing angle control line VCL2.

The first viewing angle control line VCL1 and the second viewing angle control line VCL2 can be connected to the control driver 400 in the first area AR1 of the light emitting display panel 100, and can extend from the first area AR1 to a second area opposite to the first area AR1.

In this case, the first viewing angle control line VCL1 and the second viewing angle control line VCL2 can be provided for at least two unit pixel driving circuits UPDC provided along the scan line SL. A unit pixel driving circuit UPDC is included in a unit pixel UP. The unit pixel UP can output white light, for example, and can include at least three subpixels SP. As described above, the subpixel SP can include the subpixel driving circuit SPDC, the first light emitting device ED1, and a second light emitting device ED2. The unit pixel driving circuit UPDC can include at least three subpixel driving circuits SPDC provided in the unit pixel UP.

However, the first viewing angle control line VCL1 and the second viewing angle control line VCL2 can be provided in each of m light emitting areas provided in the display area DA. In this case, m light emitting areas can be provided along a direction parallel to the scan line SL, m light emitting areas can be provided along a direction parallel to the data line DL, and m light emitting areas can include at least two light emitting areas provided along a direction parallel to the scan line SL and at least two light emitting areas provided along a direction parallel to the data line DL.

For example, when the display area DA is divided into twelve light emitting areas, gates of the first viewing angle control transistors Tvc1 provided in a first light emitting area can be connected to the first viewing angle control line VCL1 extending to the first light emitting area, and gates of the second viewing angle control transistors Tvc2 provided in the first light emitting area can be connected to the second viewing angle control line VCL2 extending to the first light emitting area.

Also, gates of a 12th viewing angle control transistors Tvc1 provided in a 12th light emitting area can be connected to the first viewing angle control line VCL1 extending to the 12th light emitting area, and gates of the second viewing angle control transistors Tvc2 provided in the 12th light emitting area can be connected to the second viewing angle control line VCL2 extending to the 12th light emitting area.

In this case, the first viewing angle control line VCL1 and the second viewing angle control line VCL2 provided in the first light emitting area are lines different from the first viewing angle control line VCL1 and the second viewing angle control line VCL2 provided in the 12th light emitting area. That is, the first viewing angle control line VCL1 and the second viewing angle control line VCL2 can be provided in each of the light emitting areas. The first viewing angle control line VCL1 and the second viewing angle control line VCL2 provided in each of the light emitting areas can be connected to the control driver 400.

A polarity type of the first viewing angle control transistor Tvc1 can be the same as a polarity type of the second viewing angle control transistor Tvc2.

For example, when the first viewing angle control transistor Tvc1 is an N-type transistor, the second viewing angle control transistor Tvc2 can be an N-type transistor, and when the first viewing angle control transistor Tvc1 is a P-type transistor, the second viewing angle control transistor Tvc2 can be a P-type transistor.

In this case, when the first viewing angle control transistor Tvc1 is turned on, the second viewing angle control transistor Tvc2 can be turned off, and when the first viewing angle control transistor Tvc1 is turned off, the second viewing angle control transistor Tvc2 can be turned on.

For example, as illustrated in FIG. 2, the gate of the first viewing angle control transistor Tvc1 can be connected to the first viewing angle control line VCL1 and the gate of the second viewing angle control transistor Tvc2 can be connected to the second viewing angle control line VCL2. Therefore, when signals of different levels are input through the first viewing angle control line VCL1 and the second viewing angle control line VCL2, one of the first viewing angle control transistor Tvc1 and the second viewing angle control transistor Tvc2 can be turned on, and the other can be turned off.

More specifically, in FIG. 2, when a first control signal having a low level is input to the first viewing angle control line VCL1 and a second control signal having a high level is input to the second viewing angle control line VCL2, the first viewing angle control transistor Tvc1 formed of the P-type transistor can be turned on, and the second viewing angle control transistor Tvc2 formed of the P-type transistor can be turned off.

Further, in FIG. 2, when a first control signal having the high level is input to the first viewing angle control line VCL1 and a second control signal having the low level is input to the second viewing angle control line VCL2, the first viewing angle control transistor Tvc1 formed of the P-type transistor can be turned off, and the second viewing angle control transistor Tvc2 formed of the P-type transistor can be turned on.

However, the polarity type of the first viewing angle control transistor Tvc1 can be different from the polarity type of the second viewing angle control transistor Tvc2.

For example, when the first viewing angle control transistor Tvc1 is an N-type transistor, the second viewing angle control transistor Tvc2 can be a P-type transistor, and when the first viewing angle control transistor Tvc1 is a P-type transistor, the second viewing angle control transistor Tvc2 can be an N-type transistor.

In this case, the gate of the first viewing angle control transistor Tvc1 and the gate of the second viewing angle control transistor Tvc2 can be connected to one viewing angle control line (e.g., the first viewing angle control line VCL1). That is, each of the subpixels SP can be connected to one viewing angle control line.

In this case, when the first viewing angle control transistor Tvc1 is turned on, the second viewing angle control transistor Tvc2 can be turned off, and when the first viewing angle control transistor Tvc1 is turned off, the second viewing angle control transistor Tvc2 can be turned on.

For example, when a viewing angle control signal VCS having the high level or the low level is input through the first viewing angle control line VCL1 connected to the gate of the first viewing angle control transistor Tvc1 and the gate of the second viewing angle control transistor Tvc2, one of the first viewing angle control transistor Tvc1 and the second viewing angle control transistor Tvc2 can be turned on, and the other can be turned off.

As illustrated in FIG. 2, the subpixel driving circuit PDC can further include a connection transistor Tsw3 and emission transistors Tsw4a and Tsw4b.

A first terminal of the connection transistor Tsw3 can be connected to the gate of the driving transistor Tdr, a second terminal of the connection transistor Tsw3 can be connected to the second terminal of the driving transistor Tdr, and a gate of the connection transistor Tsw3 can be connected to the reference control line RCL.

A first terminal of a first emission transistor Tsw4a can be connected to the second terminal of the switching transistor Tsw1, a second terminal of the first emission transistor Tsw4a can be connected to the reference line RL, and a gate of the first emission transistor Tsw4a can be connected to an emission line EL.

A first terminal of the second emission transistor Tsw4b can be connected to the second terminal of the driving transistor Tdr, a second terminal of the second emission transistor Tsw4b can be connected to the first viewing angle control transistor Tvc1 and the second viewing angle control transistor Tvc2, and a gate of the second emission transistor Tsw4b can be connected to the emission line EL. An emission signal EM can be supplied to the emission line EL. The first light emitting device ED1 connected to the subpixel driving circuit SPDC can include a first electrode supplied with a first voltage ELVDD through the driving transistor Tdr and the first viewing angle control transistor Tvc1, a second electrode connected to a second voltage supply line PLB supplied with a second voltage ELVSS, and a light emitting layer provided between the first electrode and the second electrode.

The second light emitting device ED2 connected to the subpixel driving circuit SPDC can include a first electrode which receives the first voltage ELVDD through the driving transistor Tdr and the second viewing angle control transistor Tvc2, a second electrode connected to the second voltage supply line PLB supplied with the second voltage ELVSS, and a light emitting layer provided between the first electrode and the second electrode.

The structure of the subpixel SP applied to a light emitting display apparatus according to an embodiment of the present disclosure is not limited to the structure illustrated in FIG. 2. Accordingly, the structure of the subpixel SP can be changed to various shapes.

Particularly, the subpixel driving circuit SPDC applied to a light emitting display apparatus according to an embodiment of the present disclosure, as illustrated in FIG. 2, can include a light emitting control unit ECU and a viewing angle control unit VCU. The light emitting control unit ECU can control a level of current supplied to the light emitting device ED1 or ED2 and a timing at which the current is supplied to the light emitting device ED1 or ED2. The viewing angle control unit VCU can control a viewing angle of light to be output from the light emitting device ED1 or ED2. In this case, the structure and function of the light emitting control unit ECU can be changed in various shape.

The control driver 400 can realign input image data Ri, Gi, and Bi transmitted from an external system 600 by using a timing synchronization signal TSS transmitted from the external system and can generate a data control signal DCS which is to be supplied to the data driver 300 and a gate control signal GCS which is to be supplied to the gate driver 200.

To this end, as illustrated in FIG. 3, the control driver 400 can include a data aligner 430 which realigns input image data Ri, Gi, and Bi to generate image data Data and transmits the image data Data to the data driver 300, a control signal generator 420 which generates the gate control signal GCS and the data control signal DCS by using the timing synchronization signal TSS, an input unit 410 which transmits the timing synchronization signal TSS transmitted from the external system 600 to the control signal generator 420 and transmits the input image data Ri, Gi, and Bi transmitted from the external system 600 to the data aligner 430, and an output unit 440 which supplies the data driver 300 with the image data Data generated by the data aligner 430 and the data control signal DCS generated by the control signal generator 420 and supplies the gate driver 200 with the gate control signal GCS generated by the control signal generator 420. The gate control signal GCS can be supplied to the gate driver 200 through gate control line GCL.

The control signal generator 420 can generate a power control signal supplied to the power supply unit 500.

The control driver 400 can further include a storage unit for storing various information. The storage unit 450 can be included in the control driver 400 as illustrated in FIG. 3, but can be separated from the control driver 400 and provided independently.

The control signal generator 420 can generate viewing angle control signals VCS and supply them to viewing angle control lines VCL.

The viewing angle control signals VCS can be supplied to viewing angle control units VCU provided in subpixels SP through the viewing angle control lines VCL.

To this end, the control signal generator 420 can include a gate control signal generator 421 for generating gate control signal GCS and a viewing angle control signal generator 422 for generating viewing angle control signals VCS.

The external system 600 can perform a function of driving the control driver 400 and an electronic device.

For example, when the electronic device is mounted on a vehicle, the external system 600 can receive various kinds of sound information, image information, and letter information over a communication network and can receive various image information related to an operation of the vehicle over other electronic devices mounted on the vehicle. The external system 600 can transmit the received image information to the control driver 400. The external system 600 can convert the image information into input image data Ri, Gi, and Bi and transmit the input image data Ri, Gi, and Bi to the control driver 400.

The power supply unit 500 can generate various powers and supply the generated powers to the control driver 400, the gate driver 200, the data driver 300, and the light emitting display panel 100.

The gate driver 200 can be provided in the display area DA together with the subpixels SP.

The gate driver 200 can supply scan pulses to the scan lines SL.

When a scan pulse generated by the gate driver 200 is supplied to a gate of the switching transistor Tsw1 included in the subpixel SP, the switching transistor Tsw1 can be turned on. When the switching transistor Tsw1 is turned on, data voltage Vdata supplied through a data line DL can be supplied to the subpixel SP.

When a scan-off signal generated by the gate driver 200 is supplied to the switching transistor Tsw1, the switching transistor Tsw1 can be turned off. When the switching transistor Tsw1 is turned off, a data voltage may not be supplied to the subpixel SP any longer.

The scan signal SS supplied to the scan line SL can include the scan pulse and the scan-off signal.

To supply scan signals SS1 to SSg to scan lines SL, the gate driver 200, as illustrated in FIG. 4, can include a scan driver 210, and the scan driver 210 can include scan stages SST1 to SSTg connected to scan lines SL.

Each of the scan stages SST1 to SSTg can be connected to one scan line SL, but can be connected to at least two scan lines SL.

In order to generate scan pulses, a scan start signal SVST and at least one scan clock SCLK which are generated by the control signal generator 420 can be transferred to the gate driver 200. For example, the scan start signal SVST and the at least one scan clock SCLK can be included in the gate control signal GCS.

One of the scan stages SST1 to SSTg can be driven by a scan start signal SVST to output a scan pulse to a scan line SL. The scan pulse can be generated by a scan clock SCLK.

At least one of signals output from a scan stage SST where a scan pulse is output can be supplied to another scan stage SST to drive another scan stage SST. Accordingly, a scan pulse can be output in another scan stage SST.

For example, the scan stages SST can be sequentially driven to sequentially supply the scan pulses to the scan lines SL.

As described above, each of the scan stages SST1 to SSTg can be connected to one scan line SL, but can also be connected to at least two scan lines SL.

Also, when the subpixel SP has the structure illustrated in FIG. 2, the gate driver 200 can be connected to the reference control lines RCL. The reference control signals RCS output through the reference control lines RCL can be generated by the same or similar method to a method by which scan signals are generated, and then can be sequentially output to the reference control lines RCL.

In this case, a stage connected to the scan line SL illustrated in FIG. 2 and a stage connected to the reference control line RCL illustrated in FIG. 2 may be the same or different.

For example, the scan stages SST1 to SSTg can generate scan signals SS supplied to the scan lines SL and reference control signals RCS supplied to the reference control lines RCL.

However, when the reference control signals RCS have a completely different period or pulse width from the scan signals SS, or the reference control signals RCS are generated by a method different from the method of generating the scan signals SS, the gate driver 200 can include a scan driver 210 for generating scan signals SS and a reference driver 220 for generating reference control signals RCS.

In this case, the scan driver 210 can include scan stages SST1 to SSTg illustrated in FIG. 4A.

A structure of the reference driver 220 can be similar to that of the scan driver 210, and a method in which the reference driver 220 generates the reference control signals RCS can be similar to a method in which the scan driver 210 generates the scan signals SS.

For example, in order to supply the reference control signals RCS1 to RCSg to the reference control lines SCL, the reference driver 220 can include reference stages RST1 to RSTg connected to the reference control lines SCL, as illustrated in FIG. 4B.

Each of the reference stages RST1 to RSTg can be connected to one reference control line RSL, but can also be connected to at least two reference control lines RCL.

The reference control signal RCS can include a reference pulse capable of turning on the first reference transistor Tsw2a and the second reference transistor Tsw2b illustrated in FIG. 2, and a reference-off signal capable of turning off the first reference transistor Tsw2a and the second reference transistor Tsw2b.

To generate reference pulses, a reference start signal RVST and at least one reference clock RCLK generated by the control signal generator 420 can be transmitted to the reference driver 220. That is, the reference start signal RVST and the at least one reference clock RCLK can be included in the gate control signal GCS.

One of the reference stages RST1 to RSTg can be driven by the reference start signal RVST to output a reference pulse to the reference control line RCL. The reference pulse can be generated by the reference clock RCLK.

At least one of the signals output from a reference stage RST where a reference pulse is output can be supplied to another reference stage RST to drive another reference stage RST. Accordingly, a reference pulse can also be output in another reference stage RST.

For example, the reference stages RST can be sequentially driven to sequentially supply the reference pulses to the reference control lines RCL.

Also, as illustrated in FIG. 2, when the emission line EL to which the emission signal EM is supplied is connected to the subpixel SP, after the emission signals EM are generated in the gate driver 200 by the same or similar method to the scan signals SS or the reference control signals RCS, the emission signals EM can be output to the emission lines EL.

For example, the gate driver 200 can generate scan signals SS and reference control signals RCS, and can also generate emission signals EM.

The emission signals EM can be generated by the scan driver 210 illustrated in FIG. 4A, can be generated by the reference driver 220 illustrated in FIG. 4B, or can be generated by an emission driver 230 illustrated in FIG. 4C.

A structure of the emission driver 230 can be similar to that of the scan driver 210 or the reference driver 220. Also, a method in which the emission driver 230 generates emission signals EM can be similar to a method in which the scan driver 210 generates scan signals SS or a method in which the reference driver 220 generates reference control signals RCS.

For example, in order to supply the emission signals EM1 to EMg to the emission lines EL, the emission driver 230 can include emission stages EST1 to ESTg connected to the emission lines ML, as illustrated in FIG. 4C.

Each of the emission stages EST1 to ESTg can be connected to one emission line EL, but can also be connected to at least two emission lines EL.

The emission signal EL can include an emission pulse capable of turning on the first emission transistor Tsw4a and the second emission transistor Tsw4b illustrated in FIG. 2, and an emission-off signal capable of turning off the first emission transistor Tsw4a and the second emission transistor Tsw4b.

In order to generate the emission pulses, an emission start signal EVST and at least one emission clock ECLK generated by the control signal generator 420 can be transmitted to the emission driver 230. That is, the emission start signal EVST and the at least one emission clock ECLK can be included in the gate control signal GCS.

One of the emission stages EST1 to ESTg can be driven by the emission start signal EVST to output an emission pulse to the emission line EL. The emission pulse can be generated by the emission clock ECLK.

At least one of the signals output from an emission stage EST where an emission pulse is output can be supplied to another emission stage EST to drive another emission stage EST. Accordingly, an emission pulse can also be output from another emission stage EST.

That is, the emission stages EST can be sequentially driven to sequentially supply the emission pulses to the emission lines EL.

The gate driver 200 can generate scan signals SS, reference control signals RCS, and emission signals EM by using only the scan driver 210. Also, the gate driver 200 can include at least one of the reference driver 220 and the emission driver 230 and the scan driver 210 in order to generate the scan signals SS, the reference control signal RCS, and the emission signals EM.

Hereinafter, a gate driver 200 including the scan driver 210, the reference driver 220, and the emission driver 230 is described as an example of a gate driver applied to a light emitting display apparatus according to the present disclosure.

Finally, the data driver 300 can supply data voltages Vdata to the data lines DL1 to DLd.

To this end, the data driver 300, as illustrated in FIG. 5, can include a shift register 310 which outputs a sampling signal, a latch 320 which latches image data Data received from the control driver 400, a digital-to-analog converter 330 which converts the image data Data, transmitted from the latch 320, into a data voltage Vdata and outputs the data voltage Vdata, and an output buffer 340 which outputs the data voltage, transmitted from the digital-to-analog converter 330, to the data line DL on the basis of a source output enable signal SOE.

The shift register 310 can output the sampling signal by using the data control signal DCS received from the control signal generator 420. For example, the data control signals DCS transmitted to the shift register 310 can include a source start pulse SSP and a source shift clock signal SSC.

The latch 320 can latch image data Data sequentially received from the control driver 400, and then output the image data Data to the digital-to-analog converter 330 at the same time on the basis of the sampling signal.

The digital-to-analog converter 330 can convert the image data Data transmitted from the latch 320 into data voltages Vdata and output the data voltages Vdata.

The output buffer 340 can simultaneously output the data voltages Vdata transmitted from the digital-to-analog converter 330 to data lines DL1 to DLd of the light emitting display panel 100 on the basis of the source output enable signal SOE transmitted from the control signal generator 420.

To this end, the output buffer 340 can include a buffer 341 which stores the data voltage Vdata transmitted from the digital-to-analog converter 330 and a switch 342 which outputs the data voltage Vdata stored in the buffer 341 to the data line DL on the basis of the source output enable signal SOE.

For example, when the switches 342 are turned on based on the source output enable signal SOE simultaneously supplied to the switches 342, the data voltages Vdata stored in the buffers 341 can be supplied to the data lines DL1 to DLd through the switches 342.

The data voltages Vdata supplied to the data lines DL1 to DLd can be supplied to subpixels SP connected to a scan line SL supplied with a scan pulse.

Hereinafter, additional features for the configurations described above will be described.

The display area DA can include pixel row lines and pixel column lines provided with subpixels SP. For example, the pixel row lines can mean subpixels SP provided along a first direction (X-axis direction) illustrated in FIG. 1, and the pixel column lines can mean subpixels SP provided along a second direction (Y-axis direction) illustrated in FIG. 1.

A subpixel SP may be any one of a red subpixel emitting red light, a green subpixel emitting green light, a blue subpixel emitting blue light, and a white subpixel emitting white light. A unit pixel UP can include at least two subpixels. For example, white light can be output by a unit pixel UP. Hereinafter, a light emitting display apparatus according to the present disclosure will be described using a unit pixel UP including three subpixels SP, for example, a red subpixel, a green subpixel, and a blue subpixel.

The subpixel SP can include the first and second light emitting devices ED1 and ED2, the subpixel driving circuit SPDC including transistors which drive the first and second light emitting devices ED1 and ED2, a first lens disposed on the first light emitting device ED1, and a second lens disposed on the second light emitting device ED2.

A first light emitting unit can include the first light emitting device ED1 driven by the first viewing angle control transistor Tvc1 and the first lens disposed on the first light emitting device ED1. Also, a second light emitting unit can include the second light emitting device ED2 driven by the second viewing angle control transistor Tvc2 and the second lens disposed on the second light emitting device ED2.

The first light emitting unit can be driven by the first viewing angle control transistor Tvc1, and the second light emitting unit can be driven by the second viewing angle control transistor Tvc2.

The first viewing angle control transistor Tvc1 can be connected between the first light emitting unit and the driving transistor Tdr which controls a level of current supplied to the first or second light emitting unit. The second viewing angle control transistor Tvc2 can be connected between the driving transistor Tdr and the second light emitting unit. The second emission transistor Tsw4b can be connected between the first viewing angle control transistor Tvc1 and the driving transistor Tdr and between the second viewing angle control transistor Tvc2 and the driving transistor Tdr.

The first lens provided in the first light emitting unit and the second lens provided in the second light emitting unit can have different shapes. Particularly, an exit angle, that is, a viewing angle, of a light output through the first lens can be different from a viewing angle of a light output through the second lens.

For example, the subpixel SP can operate in a wide viewing angle mode or a share mode (hereinafter, simply referred to as a share mode (SM)) by driving the first light emitting device ED1 to output a light through the first lens. Moreover, the subpixel SP can operate in a narrow viewing angle mode or privacy mode (hereinafter, simply referred to as a privacy mode (PM)) which limits a viewing angle by driving the second light emitting device ED2 to output a light through the second lens.

The narrow viewing angle mode can denote a mode having a narrower viewing angle (hereinafter, simply referred to as a narrow viewing angle or a second viewing angle) than a viewing angle (hereinafter, simply referred to as a wide viewing angle or a first viewing angle) in the wide viewing angle mode.

That is, the light emitting display apparatus according to an embodiment of the present disclosure can selectively drives the first light emitting device ED1 and the second light emitting device ED2 of the subpixel SP, thereby controlling a viewing angle of the subpixel SP. A detailed description thereof will be provided later.

In the display area DA, a light emitting area operating in the shared mode (SM) and a light emitting area operating in the privacy mode (PM) can be variously changed based on the arrangement position of a viewing angle control line unit VCLU including at least one viewing angle control line VCL. In the following description, the light emitting area can mean an area in which the shared mode (SM) or the privacy mode (PM) is implemented by the unit pixel driving circuits UPDC connected to the viewing angle control line unit VCLU.

For example, when the viewing angle control line unit VCLU is provided along the second direction Y and the viewing angle control line unit VCLU is provided between two unit pixel driving circuits UPDC provided along the first direction X, as illustrated in FIG. 1, areas in which light emitting devices of unit pixels UP connected to the left side of the viewing angle control line unit VCLU and light emitting devices of unit pixels UP connected to the right side of the viewing angle control line unit VCLU are provided can form a single light emitting area.

For another example, when the viewing angle control line unit VCLU is provided along the second direction Y and the viewing angle control line unit VCLU is provided in the middle of four unit pixel driving circuits UPDC provided along the first direction X, areas in which light emitting devices of unit pixels UP connected to the left side of the viewing angle control line unit VCLU and light emitting devices of unit pixels UP connected to the right side of the viewing angle control line unit VCLU are provided can form a single light emitting area.

Therefore, for example, if the light emitting display panel 100 illustrated in FIG. 1 includes 100 viewing angle control line units VCLU, the light emitting display panel 100 can include 100 light emitting areas, and if the light emitting display panel 100 illustrated in FIG. 1 includes 10,000 viewing angle control line units VCLU, the light emitting display panel 100 can include 10,000 light emitting areas.

That is, in the light emitting display panel illustrate in FIG. 1, the light emitting areas can be variously set based on the arrangement positions and arrangement intervals of the viewing angle control line units VCLU.

When the first light emitting devices ED1 are driven in unit pixels UP connected to the viewing angle control line unit VCLU and light is output through the first lenses, a light emitting area including the unit pixels UP can operate in the wide viewing angle mode. Also, when the second light emitting devices ED2 are driven in unit pixels UP connected to the viewing angle control line unit VCLU and light is output through the second lenses, a light emitting area including the unit pixels UP can operate in the narrow viewing angle mode.

In this case, when the first light emitting devices ED1 are driven in unit pixels UP connected to another viewing angle control line unit VCLU and light is output through the first lenses, a light emitting area including the unit pixels UP can operate in the wide viewing angle mode. Also, when the second light emitting devices ED2 are driven in unit pixels UP connected to another viewing angle control line unit VCLU and light is output through the second lenses, a light emitting area including the unit pixels UP can operate in the narrow viewing angle mode.

For example, each of the light emitting areas can independently operate in the wide viewing angle mode or the narrow viewing angle mode.

Accordingly, positions of light emitting areas operating in the wide viewing angle mode and positions of light emitting areas operating in the narrow viewing angle mode can be variously changed.

For example, the positions of the light emitting areas operating in the wide viewing angle mode and the positions of the light emitting areas operating in the narrow viewing angle mode can be variously changed based on the arrangement positions and arrangement intervals of the viewing angle control line units VCLU and can be variously changed based on types of the viewing angle control signals supplied to the viewing angle control line units VCLU.

To provide an additional description, in the light emitting display panel 100 illustrated in FIG. 1, light emitting areas can be divided along the first direction X, and the number of light emitting areas divided along the first direction can be variously changed based on the arrangement position and arrangement interval of the viewing angle control line units VCLU, as described above.

The light emitting areas can be divided along the second direction Y of the light emitting display panel 100 illustrated in FIG. 1. In this case, at least two light emitting areas can be divided along one viewing angle control line unit VCLU. In this case, at least one viewing angle control line VCL can be connected to each of the at least two light emitting areas. Accordingly, the at least two light emitting areas can operate in the same mode or can operate in different modes.

To this end, one viewing angle control line unit VCLU can include at least two viewing angle control lines VCLs connected to at least two light emitting areas.

One viewing angle control line VCL can be connected to one light emitting area, or two viewing angle control lines VCL can be connected to one light emitting area.

For example, as described above, when the first viewing angle control transistor Tvc1 and the second viewing angle control transistor Tvc2 which are turned on or off by the viewing angle control signal VCS are formed of the same type, as illustrated in FIG. 2, two viewing angle control lines VCL can be connected to one light emitting area. However, when the first viewing angle control transistor Tvc1 and the second viewing angle control transistor Tvc2 are formed of different types, one viewing angle control line VCL can be connected to one light emitting area.

As described above, the arrangement structure of the light emitting areas, the number of viewing angle control lines VCL connected to the light emitting area, and the number of viewing angle control lines VCL provided in one viewing angle control line unit VCLU can be variously changed based on the structure of the subpixel SP and the arrangement position and arrangement intervals of the viewing angle control line unit VCLU.

The light emitting display apparatus according to an embodiment of the present disclosure can further include a touch screen disposed in the display area DA to sense the user's touch.

The touch screen can be bonded to the light emitting display panel 100 or can be embedded into the light emitting display panel 100.

For example, the light emitting display panel 100 can include a pixel driving circuit layer including transistors disposed on a substrate, a light emitting device layer including light emitting devices disposed on the pixel driving circuit layer, an encapsulation layer disposed to encapsulate the light emitting device layer, a touch sensor array including touch electrodes disposed on the encapsulation layer, and a lens array disposed on the touch sensor array. In this case, the light emitting display panel 100 can further include an optical film, an optical clear adhesive (OCA), a cover substrate, and a protection film which are sequentially disposed on the lens array. The light emitting display panel 100 can further include a color filter array including a color filter and a black matrix disposed between the touch sensor array and the lens array.

As described above, the gate driver 200 can generate scan signals SS and emission signals EM and can also generate reference control signals RCS. In the following description, a generic name for the scan signal SS, emission signal EM, and reference control signal RCS can be gate signal.

That is, the gate driver 200 can supply at least one gate signal to each of the pixel row lines by using the gate control signal GCS supplied from the control driver 400. For example, a subpixel SP to which three gate signals SS, EM, and RCS are supplied is illustrated in FIG. 2.

The transistors provided in the subpixels SP and the transistors included in the gate driver 200 in the display area DA can be formed by using at least one of an LTPS transistor using a low temperature poly silicon (LTPS) and an oxide transistor using a metal-oxide semiconductor. Particularly, in order to reduce power consumption, the LTPS transistor and the oxide transistor can coexist in the light emitting display panel 100.

The data driver 300 can consist of a data drive IC (Integrated Circuit), as illustrated in FIG. 1. In this case, at least one data driver IC can be mounted on the light emitting display panel 100. FIG. 1 shows a light emitting display panel 100 on which four data drivers 300 consisting of four data driver ICs are mounted.

Each of the data driver ICs can be individually mounted on each circuit film. The circuit film on which the data drive IC is mounted can be bonded to the non-display area NDA in which a pad area of the display panel 100 is disposed through an anisotropic conductive film (ACF). The circuit film may be a chip on film (COF). Moreover, in addition to the COF, FPC (Flexible Printed Circuit) or FFC (Flexible Flat Cable) can be used as the circuit film.

The control driver 400 can control the gate driver 200 and the data driver 300 by using timing synchronization signals TSS supplied from the external system 600 and timing setting information stored therein.

To this end, the control driver 400 can generate gate control signal GCS which controls a driving timing of the gate driver 200 and supply them to the gate driver 200 and generate data control signal DCS which controls a driving timing of the data driver 300 and supply them to the data driver 300.

Moreover, the control driver 400 can perform various image processing which include image quality correction, deterioration correction, and luminance correction for the reduction of power consumption, for received input image data Ri, Gi, and Bi, and then can supply the image-processed data Data to the data driver 300.

Hereinafter, for convenience of description, as illustrated in FIG. 1, a light emitting display panel with a viewing angle control line unit VCLU between two-unit pixel driving circuits UPDC adjacent to each other in the first direction X is described as an example of a light emitting display panel 100 applied to a light emitting display apparatus according to the present disclosure.

For example, as illustrated in FIG. 1, when the viewing angle control line unit VCLU is provided along the second direction Y and the viewing angle control line unit VCLU is provided between two unit pixel driving circuits UPDC provided along the first direction X, areas in which light emitting devices of unit pixels UP connected to the left side of the viewing angle control line unit VCLU and light emitting devices of unit pixels UP connected to the right side of the viewing angle control line unit VCLU are provided can form a single light emitting area.

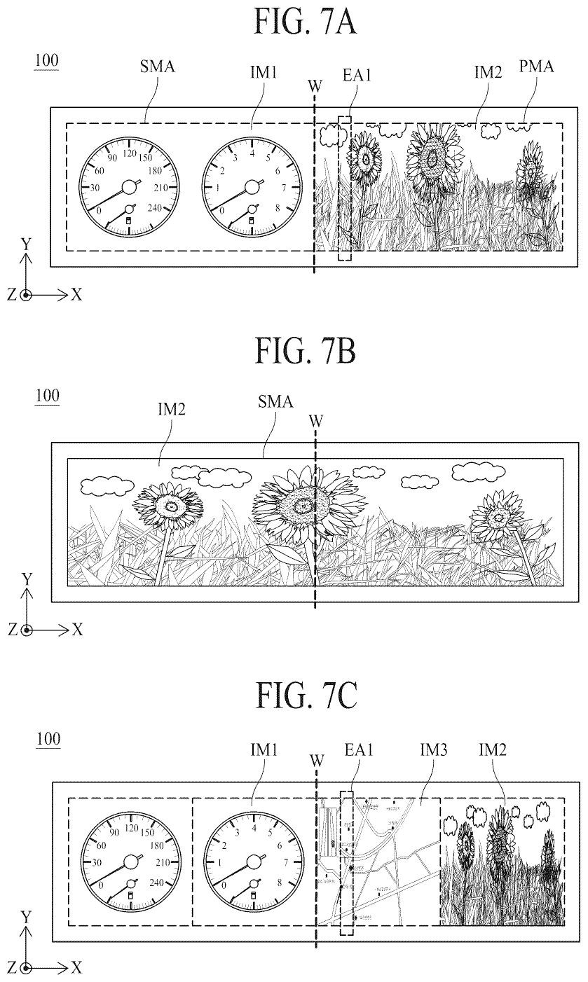

FIG. 6 is an exemplary diagram illustrating an internal structure of a vehicle to which a light emitting display apparatus according to an embodiment of the present disclosure is applied, and FIGS. 7A to 7C are exemplary diagrams illustrating how viewing angles of light emitting areas change in a light emitting display panel according to an embodiment of the present disclosure.

For example, as illustrated in FIG. 6, a light emitting display apparatus 10 according to an embodiment of the present disclosure can be placed in a center of a vehicle dashboard to display images to both a driver and a passenger in a passenger seat. In this case, one light emitting area can include areas in which light emitting devices of unit pixels UP connected to the left side of the viewing angle control line unit VCLU and light emitting devices of unit pixels UP connected to the right side of the viewing angle control line unit VCLU are provided.

The viewing angles of the light emitting areas provided on the light emitting display panel 100 can be changed independently.

Here, the viewing angles mean the wide viewing angle and the narrow viewing angle. The wide viewing angle means a wider viewing angle than the narrow viewing angle. In the following description, a light emitting area where an image with the wide viewing angle is output is referred to as a wide viewing angle mode area or a share mode area, and a light emitting area where an image with the narrow viewing angle is output is referred to as a narrow viewing angle mode area or a privacy mode area.

First, referring to FIGS. 1 and 7A, the light emitting areas provided on the left side of the centerline W of the light emitting display panel 100 can provide a first image IM1 having the wide viewing angle in the left-right direction to a driver and a of a passenger seat. Here, the center line W means a virtual line separating left and right sides of the light emitting display panel.

The first image IM1 can denote an image which provides information related to an operation of a vehicle (hereinafter simply referred to as a vehicle operation information image, and the vehicle operation information image can also be indicated by the reference numeral IM1). For example, as illustrated in FIG. 7A, the first image IM1 can provide a speed of a vehicle, a mileage of a vehicle, and an amount of fuel of a vehicle.

The vehicle operation information image needs to be seen not only to a driver but also to a passenger. Because the first image IM1 has a wide viewing angle, both a driver and a passenger can see the first image IM1. Accordingly, the light emitting areas provided on the left side of the centerline W can be the share mode areas.

Particularly, the vehicle operation information image should be displayed while the vehicle is operated, be displayed in a size which meets established standards, and be displayed in an area most visible to a driver. Therefore, while a vehicle is operated, the vehicle operation information image should be displayed unconditionally, regardless of a driver's choice, and the light emitting areas where the vehicle operation information image is output should also be fixed. For example, when the first image IM1 is the vehicle operation information image, the first image IM1 can be fixedly displayed in the light emitting areas provided on the left side of the center line W, as illustrated in FIG. 7A.

In this case, the light emitting areas provided on the right side of the center line W can display a second image IM2 having the narrow viewing angle in the left-right direction only to a passenger of a passenger seat so as not to interfere with a driver's driving.

The second image IM2 can denote, for example, an image received through various communication networks (hereinafter simply referred to as a general image, and the general image can also be indicated by the reference numeral IM2). For example, the second image IM2 can be a television video, an internet video, or a playback file video.

Because the general image is not related to an operation of a vehicle, is provided by a passenger's choice, and attracts a driver's attention, the general image can be a distraction to the driver. Therefore, the second image IM2 does not need to be seen to the driver. Because the second image IM2 has the narrow viewing angle which is visible only to a passenger, a driver cannot see the second image IM2, and only a passenger can see the second image IM2. Accordingly, the light emitting areas on the right side of the center line W can be the privacy mode areas.

However, the share mode area SMA and the privacy mode area PMA need not necessarily be divided by the center line W.

For example, the share mode area SMA and the privacy mode area PMA can be divided by one of the viewing angle control line units VCLU in the light emitting display panel 100. In this case, the viewing angle control line unit VCLU for distinguishing the share mode area SMA and the privacy mode area PMA can be set by the user or can be set by information predetermined in the control driver 400.

Referring to FIG. 7B, when a vehicle is parked or not operated, all of the light emitting areas can provide a driver and a passenger with the second image IM2 having the wide viewing angle in the left-right direction based on a user's choice.

When, as illustrated in FIG. 7A, the light emitting areas on the left side of the center line W operates in the share mode and the light emitting areas on the right side of the center line W operates in the privacy mode, some of the light emitting areas on the right side of the center line W can provide a third image IM3 having the wide viewing angle in the left-right direction to a driver and a passenger of a passenger seat, as illustrated in FIG. 7C. In this case, the rest of the light emitting areas on the right side of the center line W can provide the second image IM2.

The third image IM3 can denote an image which provides auxiliary information related to an operation of a vehicle (hereinafter simply referred to as a vehicle operation information auxiliary image, and the vehicle operation information auxiliary image can also be indicated by the reference numeral IM3). For example, as illustrated in FIG. 7C, the third image IM3 can provide location information (for example, navigation information).

The vehicle operation information auxiliary image IM3 needs to be seen not only to a driver but also to a passenger. Because the third image IM3 has the wide viewing angle, both a driver and a passenger can see the third image IM3.

To provide an additional description, the light emitting areas provided on the right side of the center line W can be divided into the share mode area SMA and the privacy mode area PMA by viewing angle control line units VCLU provided on the right side of the center line W. In this case, the vehicle operation information auxiliary image IM3 can be displayed in the share mode area SMA, and the second image IM2 can be displayed in the privacy mode area PMA.

As described above, the share mode area SMA and the privacy mode area PMA can be divided by the viewing angle control line unit VCLU. In this case, the number of the share mode areas SMA, the number of the privacy mode areas PMA, the position of the share mode area SMA, and the position of the privacy mode area PMA can be variously changed based on information set by the user or setting information stored in the control driver 400. A specific method of changing the share mode area and the privacy mode area will be described below with reference to FIG. 13.

A light emitting display apparatus 10 according to an embodiment of the present disclosure is not limited to the light emitting display apparatus for a vehicle as described above, and thus can be applied to various light emitting display apparatus such as a light emitting display apparatus for a mobile, a light emitting display apparatus for an IT device, and a light emitting display apparatus for TV.

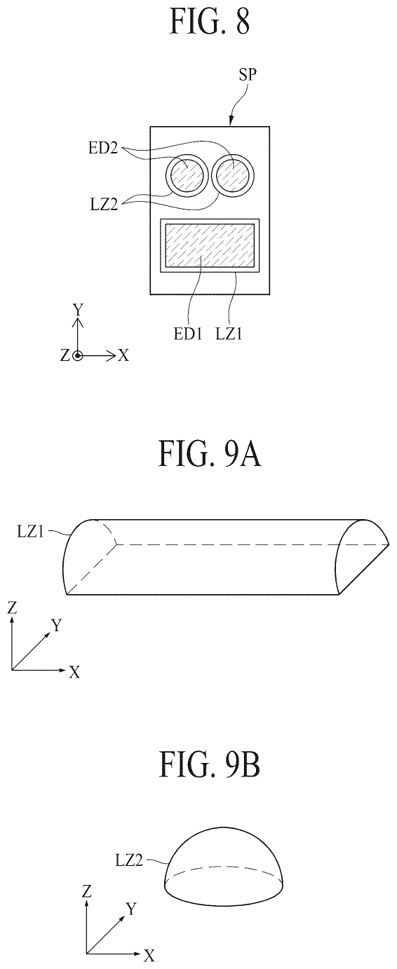

FIG. 8 is an exemplary plan view schematically illustrating a structure of a subpixel of a light emitting display panel according to an embodiment of the present disclosure, and FIGS. 9A and 9B are exemplary perspective views illustrating structures of a first lens and a second lens of a subpixel applied to a light emitting display panel according to an embodiment of the present disclosure.

As illustrated in FIG. 8, a subpixel SP applied to a light emitting display panel 100 according to an embodiment of the present disclosure can includes a first light emitting device ED1, a second light emitting device ED2, a first lens LZ1 disposed on the first light emitting device ED1, and a second lens LZ2 disposed on the second light emitting device ED2.

The first lens LZ1 can be disposed on a light traveling path of the first light emitting device ED1. The second lens LZ2 can be disposed on a light traveling path of the second light emitting device ED2. Here, the light traveling path may be, for example, a third direction Z vertical to the first direction X and the second direction Y. For example, the first lens LZ1 and the first light emitting device ED1 can be provided along the third direction Z, and the second lens LZ2 and the second light emitting device ED2 can be provided along the third direction Z.

The subpixel SP can include at least two second light emitting devices ED2, and the second lens LZ2 can be provided on the light traveling path of each of the at least two second light emitting devices ED2. The at least two second light emitting devices ED2 can share one first electrode (for example, an anode) in the subpixel SP.

In the subpixel SP, an area where the first lens LZ1 is disposed can be referred to as a first lens area, and an area where the second lens LZ2 is disposed can be referred to as a second lens area.

As illustrated in FIG. 9A, the first lens LZ1 may be a half-cylindrical lens elongated in the first direction X. As illustrated FIG. 9B, the second lens LZ2 may be a half-spherical lens. However, the shape of the first lens LZ1 and the shape of the second lens LZ2 can be variously changed.

In the following description, the first direction X can be expressed in a left-right direction, a widthwise direction, a horizontal direction, or an X-axis direction. The second direction Y can be expressed in an up-down direction, a lengthwise direction, a vertical direction or a Y axis direction. The third direction Z can be expressed in a front-rear direction, a thickness direction of a light emitting display panel 100, or a Z-axis direction.

The first lens LZ1 and the second lens LZ2 can differently control (limit) a viewing angle in the left-right direction X and can equally control (limit) a viewing angle in the up-down direction Y.

For example, because the first lens LZ1 does not limit a traveling path of a light emitted from the first light emitting device ED1 within a specific angle in the left-right direction X, the first lens LZ1 can control a viewing angle to the wide viewing angle. The second lens LZ2 cam control a viewing angle to the narrow viewing angle by limiting a traveling path of a light emitted from the second light emitting device ED2 within a specific angle in the left-right direction X.

Both the first lens LZ1 and the second lens LZ2 can control a viewing angle to the narrow viewing angle by limiting a light traveling path within a specific angle in the up-down direction Y. Accordingly, in a case when, as illustrated in FIG. 6, a light emitting display apparatus 10 is applied to a vehicle, a driver's view is prevented from being disturbed by images which is displayed on the light emitting display panel 100 to be reflected by a front glass of a vehicle.

When the first light emitting device ED1 is driven in the subpixel SP, the subpixel SP can operate in the wide viewing angle mode which does not limit a viewing angle in the left-right direction X.

When the second light emitting device ED2 is driven in the subpixel SP, the subpixel SP can operate in the narrow viewing angle mode which limits a viewing angle in the left-right direction X. The wide viewing angle mode can be described as a first mode, and the narrow viewing angle mode can be described as a second mode.

By switching the driving of the first light emitting device ED1 and the second light emitting device ED2 of the subpixel SP, the subpixel SP can be switched between the wide viewing angle mode and the narrow viewing angle mode.

To provide an additional description, as described above, the first light emitting unit can include the first light emitting device ED1 driven by the first viewing angle control transistor Tvc1 and the first lens LZ1 disposed on the first light emitting device, and the second light emitting unit can include the second light emitting device ED2 driven by the second viewing angle control transistor Tvc2 and the second lens LZ2 disposed on the second light emitting device.

In this case, only the first light emitting units or only the second light emitting units can be driven in each of the light emitting areas. For example, in each of the light emitting areas, only the first light emitting device ED1 provided in the first light emitting unit can be driven, or only the second light emitting device ED2 provided in the second light emitting unit can be driven. Accordingly, in each of the light emitting areas, only light having the wide viewing angle can be output through the first lens LZ1, or only light having the narrow viewing angle can be output through the second lens LZ2.

Accordingly, each of the light emitting areas can be the wide viewing angle mode area or the narrow viewing angle mode area.

Moreover, because the viewing angles of the light emitting areas can be controlled independently, the light emitting area can be the wide viewing angle mode area or the narrow viewing angle mode area, regardless of the position of the light emitting area.

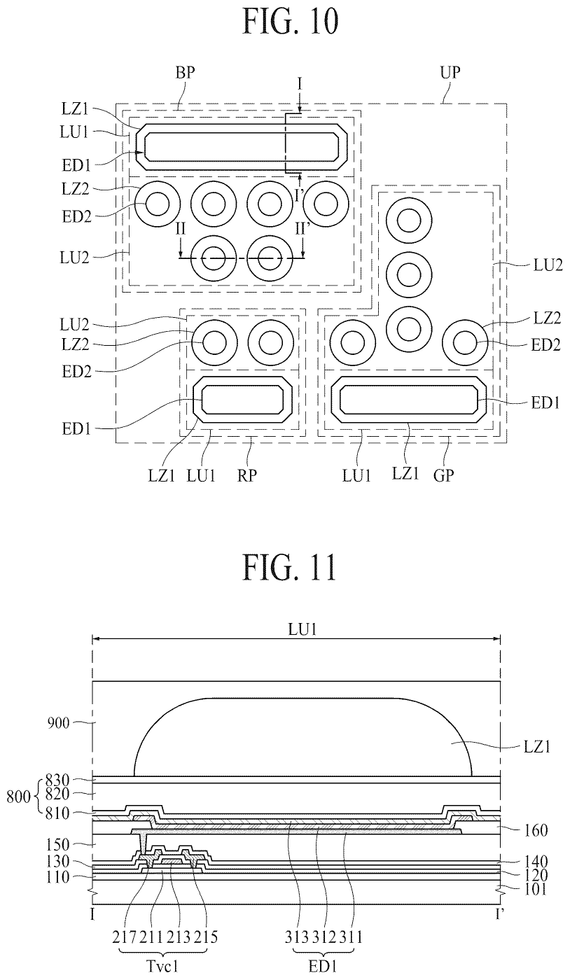

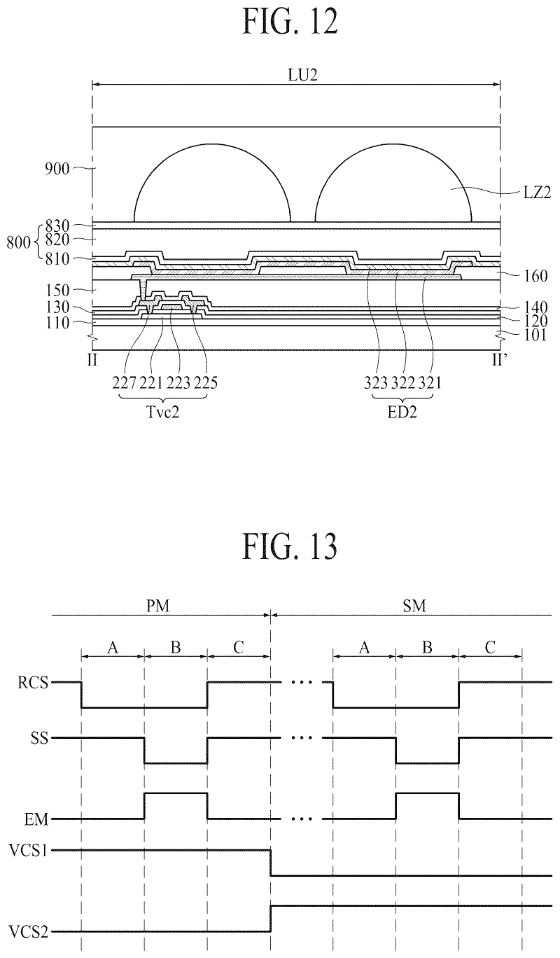

FIG. 10 is an exemplary plan view illustrating a structure of three subpixels applied to a light emitting display panel according to an embodiment of the present disclosure, FIG. 11 is an exemplary cross-sectional surface taken along line I-I′ illustrated in FIG. 10 according to an embodiment of the present disclosure, and FIG. 12 is an exemplary cross-sectional surface taken along line II-II′ illustrate in FIG. 10 according to an embodiment of the present disclosure. Particularly, FIG. 10 illustrates three subpixels BP, RP, and GP configuring a unit pixel UP, FIG. 11 illustrates a cross-sectional surface of the first light emitting unit LU1, and FIG. 12 illustrates a cross-sectional surface of the second light emitting unit LU2.

For example, the unit pixel UP capable of outputting white light can include a blue subpixel BP which emits blue light, a red subpixel RP which emits red light, and a green subpixel GP which emits green light, as illustrated in FIG. 10.

The blue subpixel BP can include a first light emitting unit LU1 and a second light emitting unit LU2. The first light emitting unit LU1 can include a first light emitting device ED1 driven by a first viewing angle control transistor Tvc1 and a first lens LZ1 overlapping the first light emitting device ED1. The second light emitting unit LU2 can include a second light emitting device ED2 driven by a second viewing angle control transistor Tvc2 and a second lens LZ2 overlapping the second light emitting device.

The red subpixel RP can include a first light emitting unit LU1 and a second light emitting unit LU2. The first light emitting unit LU1 can include a first light emitting device ED1 driven by a first viewing angle control transistor Tvc1 and a first lens LZ1 overlapping the first light emitting device ED1. The second light emitting unit LU2 can include a second light emitting device ED2 driven by a second viewing angle control transistor Tvc2 and a second lens LZ2 overlapping the second light emitting device.

The green subpixel GP can include a first light emitting unit LU1 and a second light emitting unit LU2. The first light emitting unit LU1 can include a first light emitting device ED1 driven by a first viewing angle control transistor Tvc1 and a first lens LZ1 overlapping the first light emitting device ED1. The second light emitting unit LU2 can include a second light emitting device ED2 driven by a second viewing angle control transistor Tvc2 and a second lens LZ2 overlapping the second light emitting device.

In each of the blue subpixel BP, red subpixel RP, and green subpixel GP, as described with reference to FIGS. 9A and 9B, the first lens LZ1 and the second lens LZ2 can differently control a viewing angle in the left-right direction X and can equally control a viewing angle in the up-down direction Y.

Each of the first light emitting units LU1 of the unit pixel UP can include one first light emitting device ED1 and one first lens LZ1. Each of the second light emitting units LU2 of the unit pixel UP can include at least one second light emitting device ED2 and at least one second lens LZ2. In this case, the at least two second light emitting devices ED2 can share a first electrode (for example, an anode) 321, a light emitting layer 322, and a second electrode (for example, a cathode) 323, as illustrated in FIG. 12.

The first light emitting device ED1 included in the first light emitting unit LU1 can have the same shape as a lower surface of the first lens LZ1. The size of the first lens LZ1 cam be set to be larger than the size of the first light emitting device ED1 to improve the emission efficiency of light generated from the first light emitting device ED1.

The second light emitting device ED2 included in the second light emitting unit LU2 can have the same shape as the lower surface of the second lens LZ2. The size of the second lens LZ2 can be set to be larger than the size of the second light emitting device ED2 to improve the emission efficiency of light generated from the second light emitting device ED2.

The areas of the second light emitting devices ED2 included in the second light emitting units LU2 can be the same.

However, the number of second light emitting devices ED2 included in the second light emitting unit LU2 can vary for each subpixel BP, RP, and GP. For example, as illustrated in FIG. 10, the number of second light emitting devices ED2 disposed in the second light emitting unit LU2 of the blue subpixel BP can be greater than the number of the second light emitting devices ED2 disposed in the second light emitting unit LU2 of the red subpixel RP. The number of second light emitting devices ED2 disposed in the second light emitting unit LU2 of the red subpixel RP can be less than the number of the second light emitting devices ED2 disposed in the second light emitting unit LU2 of the green subpixel GP. Accordingly, the efficiency deviation of the blue subpixel BP, red subpixel RP, and green subpixel GP in the unit pixel UP can be compensated by the number of the second light emitting device ED2 disposed in the second light emitting unit LU2.

The size of the first light emitting device ED1 can be different for each subpixel SP. For example, as illustrated in FIG. 10, the size of the first light emitting device ED1 of the blue subpixel BP can be larger than the size of the first light emitting device ED1 of the red subpixel RP. Moreover, the size of the first light emitting device ED1 of the red subpixel RP can be smaller than the size of the first light emitting device ED1 of the green subpixel GP. Accordingly, the efficiency deviation of the blue subpixel BP, red subpixel RP, and green subpixel GP in the unit pixel UP can be compensated by the sizes of the first light emitting devices ED1 disposed in the first light emitting units LU1.

A light emitting display panel 100 according to an embodiment of the present disclosure, as illustrated in FIGS. 11 and 12, can include a pixel driving circuit layer which includes a substrate 101 and transistors Tvc1 and Tvc2 disposed on the substrate 101, a light emitting device layer which includes light emitting devices ED1 and ED2 disposed on the pixel driving circuit layer, an encapsulation layer 800 disposed on the light emitting device layer, and a lens layer which includes lenses LZ1 and LZ2 disposed on the encapsulation layer 800.

A light emitting display panel 100 according to an embodiment of the present disclosure can further include a touch sensor layer disposed between the encapsulation layer 800 and the lens layer. A light emitting display panel 100 according to an embodiment of the present disclosure can further include a color filter layer including a color filter and a black matrix which are disposed between the touch sensor layer and the lens layer.

Hereinafter, a cross-sectional structure of a subpixel is described with reference to FIGS. 10 to 12. FIGS. 11 and 12 illustrate cross-sectional surfaces of the blue subpixel BP illustrated in FIG. 10. However, each of the red subpixel RP and the green subpixel GP can also have the cross-sectional structures illustrated in FIGS. 11 and 12.

That is, each of the subpixels BP, RP, and GP of the light emitting display panel according to an embodiment of the present disclosure can include the first light emitting unit LU1 illustrated in FIG. 11 and the second light emitting unit LU2 illustrated in FIG. 12.

As illustrated in FIG. 11, the first light emitting unit LU1 of the subpixel SP can include a first viewing angle control transistor Tvc1, a first light emitting device ED1 connected to the first viewing angle control transistor Tvc1, and a first lens LZ1 disposed on the first light emitting device ED1 to overlap the first light emitting device ED1.

As illustrated in FIG. 12, the second light emitting unit LU2 of the subpixel SP can include a second viewing angle control transistor Tvc2, a second light emitting device ED2 connected to the second viewing angle control transistor Tvc2, and at least one second lens LZ2 disposed on the second light emitting device ED2 to overlap the second light emitting device ED2.

In the light emitting display panel 100 according to an embodiment of the present disclosure, the pixel driving circuit layer disposed on the substrate 101 can include insulation layers stacked on the substrate 101. For example, the insulation layers can include a buffer layer 110, a gate insulation layer 120, an interlayer insulation layer 130, a passivation layer 140, and a planarization layer 150.

The substrate 101 can include an insulation material such as glass or plastic. The plastic substrate can be formed of a flexible material. For example, the substrate 101 can include at least one of acrylic resin, epoxy resin, siloxane resin, polyimide resin, and polyamide resin. That is, the substrate 101 can include an organic insulation material.

The buffer layer 110 can include an inorganic insulation material such as silicon oxide (SiOx), silicon nitride (SiNx), and aluminum oxide (Al2O3), and can have a single-layer or multi-layer structure. The buffer layer 110 can prevent impurities such as hydrogen from flowing into semiconductor layers 211 and 221 through the substrate 101.

Various transistors configuring the subpixel SP can be provided on the buffer layer 110. For example, the first viewing angle control transistor Tvc1 and the second viewing angle control transistor Tvc2 can be disposed.

Each of the transistors provided in the subpixel SP can include a gate electrode, a source electrode, and a drain electrode. In this case, the source electrode and drain electrode are not fixed and can change depending on the voltage and current direction applied to the gate electrode. Accordingly, one of the source electrode or the drain electrode can be referred to as a first electrode the other can be referred to as a second electrode. The transistors of the subpixel SP can use at least one of polysilicon semiconductor, amorphous silicon semiconductor, and oxide semiconductor. The transistors of the subpixel SP can be P-type transistors or N-type transistors, and the subpixel SP can include both P-type transistors and N-type transistors.

The first viewing angle control transistor Tvc1 includes a semiconductor layer 211, a gate electrode 213, a source electrode 215, and a drain electrode 217 which are disposed on an upper end of the buffer layer 110. The second viewing angle control transistor Tvc2 includes a semiconductor layer 221, a gate electrode 223, a source electrode 225, and a drain electrode 227 which are disposed on the buffer layer 110.

A gate insulation layer 120 can be disposed between the semiconductor layers 211 and 221 and the gate electrodes 213 and 223. An interlayer insulation layer 130 can be disposed between the gate electrodes 213 and 223 and the source and drain electrodes 215, 217, 225, and 227. The source electrode 215 and drain electrode 217 of the first viewing angle control transistor Tvc1 can be connected to a source region and drain region of the semiconductor layer 211 through contact holes penetrating the interlayer insulation layer 130 and the gate insulation layer 120. The source electrode 225 and drain electrode 227 of the second viewing angle control transistor Tvc2 can be connected to a source region and drain region of the semiconductor layer 221 through contact holes penetrating the interlayer insulation layer 130 and the gate insulation layer 120.

The semiconductor layers 211 and 221 can include polycrystalline silicon, an oxide semiconductor material, or low temperature polysilicon (LPTS). The semiconductor layers 211 and 221 can include at least one selected from IZO (InZnO)-based, IGO (InGaO)-based, ITO (InSnO)-based, IGZO (InGaZnO)-based, IGZTO (InGaZnSnO)-based, GZTO (GaZnSnO)-based, and GZO (GaZnO)-based, and ITZO (InSnZnO)-based oxide semiconductor materials. A light blocking layer can be further disposed under the semiconductor layers 211 and 221.

The gate insulation layer 120 can include an inorganic insulation material such as silicon oxide (SiOx) and silicon nitride (SiNx). The gate insulation layer 120 can include a material with a high dielectric constant. For example, the gate insulation layer 120 can include a high-K material such as hafnium oxide (HfO). The gate insulation layer 120 can have a multi-layer structure.

Viewing angle control lines VCL connected to the gate electrodes 213 and 223 can be disposed on the gate insulation layer 120.

The interlayer insulation layer 130 can include an inorganic insulation material such as silicon oxide (SiOx) and silicon nitride (SiNx). The interlayer insulation layer 130 can have a multi-layer structure.

Data lines connected to the source electrodes 215 and 225 or the drain electrodes 217 and 227 and power lines can be disposed on the interlayer insulation layer 130.

A passivation layer 140 and a planarization layer 150 can be stacked on the first and second viewing angle control transistors Tvc1 and Tvc2. The passivation layer 140 can include an inorganic insulation material such as silicon oxide (SiOx) and silicon nitride (SiNx). The planarization layer 150 can include an organic insulation material different from that of the passivation layer 140 and can provide a flat surface.

A light emitting device layer including the first light emitting device ED1 and the second light emitting device ED2 can be disposed on the planarization layer 150.

The first light emitting device ED1 includes a first electrode 311 disposed on the planarization layer 150, a light emitting layer 312 disposed on the first electrode 311, and a second electrode 313 disposed on the light emitting layer 312. The second light emitting device ED2 includes a first electrode 321 disposed on the planarization layer 150, a light emitting layer 322 disposed on the first electrode 321, and a second electrode 323 disposed on the light emitting layer 322. The first light emitting device ED1 and the second light emitting device ED2 disposed in the subpixel SP can emit light of the same color.

The first electrode 311 of the first light emitting device ED1 can be connected to any one of the source electrode 215 and the drain electrode 217 of the first viewing angle control transistor Tvc1 through a contact hole penetrating the planarization layer 150 and the passivation layer 140. The first electrode 321 of the second light emitting device ED2 can be connected to any one of the source electrode 225 and the drain electrode 227 of the second viewing angle control transistor Tvc2 through a contact hole penetrating the planarization layer 150 and the passivation layer 140.

The first electrodes 311 and 321 can include a conductive material with high reflectivity. The first electrodes 311 and 321 can include metal such as aluminum (Al), silver (Ag), titanium (Ti), and silver-palladium-copper (APC) alloy. The first electrodes 311 and 321 can further include a transparent conductive material such as indium tin oxide (ITO) or indium zinc oxide (IZO). For example, the first electrodes 311 and 321 can have a multi-layer structure Ti/Al/Ti of titanium (Ti) and aluminum (Al), a multi-layer structure ITO/AI/ITO of ITO and aluminum (Al), or a multi-layer structure ITO/APC/ITO of ITO and APC.

The light emitting layers 312 and 322 can include an emission material layer (EML) including a light emitting material. The light emitting material can include an organic material, an inorganic material, or hybrid material. The light emitting layer 312 of the first light emitting device ED1 and the light emitting layer 322 of the second light emitting device ED2 can be spaced apart from each other. Accordingly, light emission due to leakage current can be prevented.

The light emitting layers 312 and 322 can have a multi-layer structure. For example, the light emitting layers 312 and 322 can further include at least one of a hole injection layer (HIL), a hole transport layer (HTL), an electron injection layer (EIL).

The second electrodes 313 and 323 can include a conductive material which can transmits light therethrough. The second electrodes 313 and 323 can include a transparent conductive material such as ITO or IZO. The second electrodes 313 and 323 can include aluminum (Al), magnesium (Mg), silver (Ag), or an alloy thereof, and can have a thin thickness capable of transmitting light. Accordingly, light generated in each of the light emitting layers 312 and 322 can be emitted through the second electrodes 313 and 323.

The first electrode 311 of the first light emitting device ED1 can be spaced apart from the first electrode 321 of the second light emitting device ED2, and a bank insulation layer 160 can be provided between the first electrodes 311 and 321. The bank insulation layer 160 can cover the edge of each of the first electrodes 311 and 321. The bank insulation layer 160 can include an organic insulation material. The bank insulation layer 160 can include an organic material different from that of the planarization layer 150 and can have a single-layer or double-layer structure.

The bank insulation layer 160 can include an opening portion through which the first electrode 311 of the first light emitting device ED1 is exposed, and light can be output through the opening portion. The light emitting layer 312 and the second electrode 313 of the first light emitting device ED1 can be stacked on the first electrode 311 exposed by the opening portion of the bank insulation layer 160.

The bank insulation layer 160 can include an opening portion through which the first electrode 321 of the second light emitting device ED2 is exposed, and light can be output through the opening portion. The bank insulation layer 160 can include at least two opening portions provided on the first electrode 321, and thus, at least two second light emitting devices ED2 can be formed.

The light emitting layer 322 and the second electrode 323 of the second light emitting device ED2 can be stacked on the first electrode 321 exposed by the opening portion of the bank insulation layer 160. The light emitting layer 322 and the second electrode 323 of the second light emitting device ED2 can overlap the first electrode 321. In the second light emitting unit LU2, at least two second light emitting devices ED2 are independently arranged and spaced apart from each other by the bank insulation layer 160, but the second light emitting devices ED2 can share the first electrode 321, the light emitting layer 322, and the second electrode 323. Accordingly, the luminous efficiency of the second light emitting devices ED2 can be improved. The size of the second light emitting device ED2 may be smaller than the size of the first light emitting device ED1.

The second electrode 313 of the first light emitting device ED1 can be a common electrode electrically connected to the second electrode 323 of the second light emitting device ED2.

An encapsulation layer 800 can be disposed on the light emitting device layer including the first light emitting device ED1 and the second light emitting device ED2. The encapsulation layer 800 can prevent the light emitting devices ED1 and ED2 from being damaged by moisture and impact from the outside. The encapsulation layer 800 can have a multi-layer structure. For example, the encapsulation layer 800 can include a first encapsulation layer 810, a second encapsulation layer 820, and a third encapsulation layer 830, but not limited thereto. The first encapsulation layer 810, the second encapsulation layer 820, and the third encapsulation layer 830 can include an insulating material. The second encapsulation layer 820 can include a material different from that of the first encapsulation layer 810 and the third encapsulation layer 830. For example, the first encapsulation layer 810 and the third encapsulation layer 830 can be inorganic encapsulation layers including an inorganic insulation material, and the second encapsulation layer 820 can include an organic encapsulation layer including an organic insulation material. Accordingly, it is possible to more effectively prevent or at least reduce the light emitting devices ED1 and ED2 from being damaged by moisture and impact from the outside.

A lens layer including the first lens LZ1 and the second lens LZ2 can be disposed on the encapsulation layer 800.

The first lens LZ1 can be disposed on an upper end of the first light emitting device ED1 in the first light emitting unit LU1. The first lens LZ1 does not limit the path of light generated in the first light emitting device DEI to the left-right directions. Accordingly, the first lens LZ1 can output light having the wide viewing angle in the left-right direction. For example, the first lens LZ1 does not limit the path of light emitted from the first light emitting device ED1 to within a specific angle in the left-right direction. Accordingly, the first lens LZ1 can output light having the wide viewing angle in the left-right direction. Further, the first lens LZ1 can limit the path of light generated in the first light emitting device DEI to within a certain angle in the up-down direction, and thus can output light having the narrow viewing angle in the up-down direction.

The second lens LZ2 can be disposed on an upper end of the second light emitting device ED2 in the second light emitting unit LU2. The second lens LZ2 limits the path of light generated in the second light emitting device ED2 to the left-right direction. Accordingly, the second lens LZ2 can output light having the narrow viewing angle in the left-right direction. For example, the second lens LZ2 limits the path of light emitted from the second light emitting device ED2 to the left-right direction. Accordingly, the second lens LZ2 can output light having the narrow viewing angle in the left-right direction. Further, the second lens LZ2 can limit the path of light generated in the second light emitting device ED2 to within a specific angle in the up-down direction, and thus can output light having the narrow viewing angle in the up-down direction.

A lens passivation layer 900 can be provided on the first lens LZ1 and the second lens LZ2 of each subpixel area. The lens passivation layer 900 can include an organic insulation material. The refractive index of the lens passivation layer 900 can be smaller than the refractive index of the first lens LZ1 and the refractive index of the second lens LZ2. Accordingly, light passing through the first lens LZ1 and the second lens LZ2 cannot be reflected toward the direction of the substrate 101.

FIG. 13 is an exemplary timing diagram for explaining a basic driving method of a light emitting display apparatus according to an embodiment of the present disclosure. Hereinafter, a basic driving method of a light emitting display apparatus according to the present disclosure will be described with reference to a light emitting display panel which includes subpixels SP illustrated in FIG. 2 and has the structure as illustrated in FIG. 1.

In a light emitting display apparatus according to the present disclosure, in a state where one of the first viewing angle control transistor Tvc1 and the second viewing angle control transistor Tvc2 provided in the subpixel SP is turned on, the subpixel driving circuit SPDC can be driven. Accordingly, in each of the subpixels SP, only the first light emitting device ED1 connected to the first viewing angle control transistor Tvc1 can output light, or only the second light emitting device ED2 connected to the second viewing angle control transistor Tvc2 can output light.

The light output from the first light emitting device ED1 can have the first viewing angle (wide viewing angle), and the light output from the second light emitting device ED2 can have the second viewing angle (narrow viewing angle).

Accordingly, an image having the first viewing angle (wide viewing angle) can be displayed in a light emitting area where light is output only from the first light emitting devices ED1, and an image having the second viewing angle (narrow viewing angle) can be displayed in a light emitting area where light is output only from the second light emitting devices ED2.

The subpixel driving circuit SPDC applied to a light emitting display apparatus according to the present disclosure can include the light emitting control unit ECU and the viewing angle control unit VCU, as described with reference to FIG. 2.

The viewing angle control unit VCU can include the first viewing angle control transistor Tvc1 connected to the first light emitting device ED1 and the second viewing angle control transistor Tvc2 connected to the second light emitting device ED2. A gate of the first viewing angle control transistor Tvc1 can be connected to a first viewing angle control line VCL1 and a gate of the second viewing angle control transistor Tvc2 can be connected to a second viewing angle control line VCL2.

The first viewing angle control line VCL1 and the second viewing angle control line VCL2 can be provided in any one of the viewing angle control line units VCLU illustrated in FIG. 1.

In this case, the polarity type of the first viewing angle control transistor Tvc1 can be the same as the polarity type of the second viewing angle control transistor Tvc2. For example, when the first viewing angle control transistor Tvc1 is a P-type transistor, as illustrated in FIG. 2, the second viewing angle control transistor Tvc2 can also be a P-type transistor.

The light emitting control unit ECU can perform a function of supplying current to the first viewing angle control transistor Tvc1 or the second viewing angle control transistor Tvc2. To this end, the light emitting control unit ECU can be formed in the structure illustrated in FIG. 2, and can be changed to various structures other than the structure illustrated in FIG. 2.

Further, the driving method for turning on the driving transistor Tdr included in the light emitting control unit ECU to supply current to the first viewing angle control transistor Tvc1 or the second viewing angle control transistor Tvc2 can also be changed in various ways.

Therefore, hereinafter, the basic driving method of the light emitting display apparatus according to the present disclosure will be briefly described with reference to the subpixel driving circuit SPDC illustrated in FIG. 2 and the timing diagram illustrated in FIG. 13.

Particularly, hereinafter, the basic driving method of the light emitting display apparatus according to the present disclosure will be briefly described with reference to a light emitting area which is converted to the share mode (SM), where the vehicle operation information auxiliary image IM3 with the first viewing angle (wide viewing angle) is output, from the privacy mode (PM), where the general image IM2 with the second viewing angle (narrow viewing angle) is output, as illustrated in FIGS. 7A and 7C.

First, for example, when the light emitting areas provided on the right side of the center line W, as illustrated in FIG. 7A, are driven in the privacy mode (PM), any one of the light emitting areas provided on the right side of the center line W (hereinafter, simply referred to as a first light emitting area EA1) can also be driven in the privacy mode (PM).

As described above, the first light emitting area EA1 can mean an area in which unit pixels UP connected to at least one viewing angle control line VCL provided in one viewing angle control line unit VCLU are provided.

When the first light emitting area EA1 is driven in the privacy mode (PM), a first viewing angle control signal VCS1 having a high level, as illustrated in FIG. 13, can be supplied to gates of the first viewing angle control transistors Tvc1 of the subpixels SP provided in the first light emitting area EA1. In this case, a second viewing angle control signal VCS2 having a low level, as illustrated in FIG. 13, can be supplied to gates of the second viewing angle control transistors Tvc2 of the subpixels SP provided in the first light emitting area EA1.

That is, the viewing angle control signal generator 422 of the control driver 400 can supply the first viewing angle control signal VCS1 having the high level to the first viewing angle control line VCL1 provided in the viewing angle control line unit VCLU corresponding to the first light emitting area EA1. Also, the viewing angle control signal generator 422 of the control driver 400 can supply the second viewing angle control signal VCS2 having the low level to the second viewing angle control line VCL2 provided in the viewing angle control line unit VCLU.

The level of the first viewing angle control signal VCS1 supplied to the subpixels SP provided in the first light emitting area EA1 is different from the level of the second viewing angle control signal VCS2 supplied to the subpixels SP provided in the first light emitting area EA1. For example, when the first viewing angle control signal VCS1 has the high level, the second viewing angle control signal VCS2 has the low level.

In this case, as illustrated in FIG. 2, the first viewing angle control transistor Tvc1 and the second viewing angle control transistor Tvc2 which are provided in the subpixels SP can be P-type transistors.

Accordingly, while the first light emitting area EA1 is driven in the privacy mode (PM), the first viewing angle control transistors Tvc1 provided in the subpixels SP of the first light emitting area EA1 can be turned off by the first viewing angle control signal VCS1 having the high level, and the second viewing angle control transistors Tvc2 provided in the subpixels SP of the first light emitting area EA1 can be turned on by the second viewing angle control signal VCS2 having the low level.

Next, as illustrated in FIG. 13, when a reference control signal RCS having a low level, a scan signal SS having a high level, and an emission signal EM having a low level are supplied to a t-th pixel row line (t is a natural number less than or equal to g) provided in the first light emitting area EA1, the first emission transistor Tsw4a, the second emission transistor Tsw4b, the first reference transistor Tsw2a, the second reference transistor Tsw2b, and the connection transistor Tsw3 which are provided in the subpixel SP of a t-th pixel row line can be turned on, and the switching transistor Tsw1 can be turned off. Here, the t-th pixel row line can denote a pixel row line provided in the first light emitting area EA1, and particularly, the t-th pixel row line can denote the subpixels SP provided along the first direction X in the first light emitting area EA1.

Accordingly, through the first emission transistor Tsw4a, the second emission transistor Tsw4b, the first reference transistor Tsw2a, the second reference transistor Tsw2b, and the connection transistor Tsw3, a reference voltage VREF can be supplied to the gate of the driving transistor Tdr, the first electrode (anode) of the first light emitting device ED1, and the first electrode (anode) of the second light emitting device ED2.

Therefore, the gate of the driving transistor Tdr, the first electrode (anode) of the first light emitting device ED1, and the first electrode (anode) of the second light emitting device ED2 can be initialized by the reference voltage VREF.

If the second terminal of the first reference transistor Tsw2a is connected to the first terminal of the first viewing angle control transistor Tvc1 and the second terminal of the second reference transistor Tsw2b is connected to the first terminal of the second viewing angle control transistor Tvc2, because the first viewing angle control transistor Tvc1 is turned off, only the second light emitting device ED2 can be initialized by the reference voltage VREF transmitted through the second reference transistor Tsw2b and the second viewing angle control transistor Tvc2.

Hereinafter, a period during which the reference control signal RCS having the low level, the scan signal SS having the high level, and the emission signal EM having the low level are supplied to the t-th pixel row line provided in the first light emitting area EA1 is referred to as an initialization period A.

Next, after the initialization period A, a sampling period B begins.

In the sampling period B, as illustrated in FIG. 13, when the reference control signal RCS having the low level, the scan signal SS having the low level, and the emission signal EM having the high level are supplied to the t-th pixel row line provided in the first light emitting area EA1, the switching transistor Tsw1, the first reference transistor Tsw2a, the second reference transistor Tsw2b, and the connection transistor Tsw3 which are provided in the subpixel SP connected to the t-th pixel row line can be turned on and the first emission transistor Tsw4a and the second emission transistor Tsw4b can be turned off. In this case, the driving transistor Tdr can also be turned on. Because the second emission transistor Tsw4b is turned off, even if the driving transistor Tdr is turned on, current is not supplied to the second light emitting device ED2 through the second viewing angle control transistor Tvc2.

Accordingly, the data voltage Vdata transmitted through the data line DL can be charged to the first terminal of the storage capacitor Cst through the switching transistor Tsw1.

In this case, the gate of the driving transistor Tdr, which is the second terminal of the storage capacitor Cst, can be charged with the first voltage VDD and the threshold voltage (Vth) of the driving transistor Tdr.

Next, after the sampling period B, an emission period C begins.

In the emission period C, as illustrated in FIG. 13, when the reference control signal RCS having the high level, the scan signal SS having the high level, and the emission signal EM having the low level are supplied to the t-th pixel row line provided in the first light emitting area EA1, the switching transistor Tsw1, the first reference transistor Tsw2, the second reference transistor Tsw2b, and the connection transistor Tsw3 which are provided in the subpixel SP connected to the t-th pixel row line can be turned off, and the first emission transistor Tsw4a and the second emission transistor Tsw4b can be turned on.

Accordingly, the first terminal of the storage capacitor Cst can be charged with the reference voltage VREF.

In this case, a gate voltage (Vg) can be supplied to the gate of the driving transistor Tdr, which is the second terminal of the storage capacitor Cst (for example, Vg=VREF−Vdata+ELVDD+Vth). A source voltage (Vs) (for example, Vs=ELVDD) can be supplied to a source of the driving transistor Tdr.

A level of a current flowing through the driving transistor Tdr to the first light emitting device ED1 or the second light emitting device ED2 can be proportional to the square of a voltage obtained by subtracting the threshold voltage (Vth) of the driving transistor Tdr from a difference voltage (hereinafter simply referred to as a gate-source voltage (Vgs)) between the gate voltage Vg and the source voltage Vs of the driving transistor Tdr.

In the above example, a value (Vgs−Vth) obtained by subtracting the threshold voltage (Vth) of the driving transistor Tdr from the gate-source voltage (Vgs) does not include the threshold voltage (Vth) of the driving transistor Tdr, and can include the data voltage Vdata and the reference voltage VREF (for example, Vgs−Vth=[Vref−Vdata+ELVDD+Vth]−[ELVDD]−[Vth]=VREF−Vdata). Here, the reference voltage VREF is a constant voltage regardless of the threshold voltage (Vth) of the driving transistor Tdr.

Therefore, the threshold voltage (Vth) of the driving transistor Tdr does not affect the level of the current flowing through the driving transistor Tdr, and the data voltage Vdata and reference voltage VREF can affect the level of the current flowing through the driving transistor Tdr.

Accordingly, even when the driving transistor Tdr deteriorates and thus the threshold voltage (Vth) of the driving transistor Tdr changes, the first light emitting device ED1 or the second light emitting device ED2 can output light with a luminance corresponding to the data voltage Vdata.

In this case, because only the second viewing angle control transistor Tvc2 connected to the second light emitting device ED2 is turned on by the second viewing angle control signal VCS2 having the low level in the privacy mode (PM), only lights having the second viewing angle (narrow viewing angle) can be output from the subpixels SP of the t-th pixel row line provided in the first light emitting area EA1.

That is, lights having the second viewing angle can be output from the subpixels SP provided in the first light emitting area EA1, and thus, as illustrated in FIG. 7A, the general image IM2 having the second viewing angle (narrow viewing angle) can be displayed in the first light emitting area EA1.

The general image IM2 having the second viewing angle (narrow viewing angle) can be visible only to a user at a specific location, for example, a passenger. Accordingly, this mode can be the privacy mode (PM), as described above.

The processes described above can be repeated in all pixel row lines provided in the first light emitting area EA1 while the first viewing angle control signal VCS1 having the high level and the second viewing angle control signal VCS2 having the low level are supplied to the first light emitting area EA1.

Next, if the vehicle operation information auxiliary image IM3 which corresponds to the first light emitting area EA1 and has the first viewing angle (wide viewing angle) is received in the privacy mode (PM) in which the general image IM2 with the second viewing angle (narrow viewing angle) is displayed, the control driver 400 can supply the first viewing angle control signal VCS1 having the low level and the second viewing angle control signal VCS2 having the high level, as illustrated in FIG. 13, to the subpixels SP provided in the first light emitting area EA1. That is, the viewing angle control signal generator 422 of the control driver 400 can supply the first viewing angle control signal VCS1 having the low level to the first viewing angle control line VCL1 provided in the viewing angle control line unit VCLU corresponding to the first light emitting area EA1, and can supply the second viewing angle control signal VCS2 having the high level to the second viewing angle control line VCL2 provided in the viewing angle control line unit VCLU.

In this case, as illustrated in FIG. 2, the first viewing angle control transistor Tvc1 and the second viewing angle control transistor Tvc2 which are provided in the subpixels SP can be P-type transistors.

Accordingly, the first viewing angle control transistors Tvc1 provided in the subpixels SP of the first light emitting area EA1 can be turned on by the first viewing angle control signal VCS1 having the low level, and the second viewing angle control transistors Tvc2 can be turned off by the second viewing angle control signal VCS2 having the high level.

Next, the initialization period A and the sampling period B can be performed for the t-th pixel row line provided in the first light emitting area EA1.

That is, for the t-th pixel row line, the same initialization period A and sampling period B as the initialization period A and sampling period B described in the privacy mode (PM) can proceed.

Accordingly, the driving transistor Tdr provided in the t-th pixel row line can be initialized, and the data voltage Vdata can be supplied to the subpixel SP.

Finally, after the sampling period B, the emission period C begins.

In the emission period C, as illustrated in FIG. 13, when the reference control signal RCS having the high level, the scan signal SS having the high level, and the emission signal EM having the low level are supplied to the t-th pixel row line provided in the first light emitting area EA1, the switching transistor Tsw1, the first reference transistor Tsw2a, the second reference transistor Tsw2b, and the connection transistor Tsw3 which are provided in the subpixel SP connected to the t-th pixel row line can be turned off, and the first emission transistor Tsw4a and the second emission transistor Tsw4b can be turned on.

Accordingly, current flows through the driving transistor Tdr toward the first viewing angle control transistor Tvc1 and the second viewing angle control transistor Tvc2.

In this case, in the share mode (SM), because only the first viewing angle control transistor Tvc1 connected to the first light emitting device ED1 is turned on by the first viewing angle control signal VCS1 having the low level, only lights having the first viewing angle (wide viewing angle) can be output from the subpixels SP connected to the t-th pixel row line provided in the first light emitting area EA1.

That is, lights having the first viewing angle can be output from the subpixels SP provided in the first light emitting area EA1, and thus, the vehicle operation information auxiliary image IM3 having the first viewing angle (wide viewing angle) can be displayed in the first light emitting area EA1, as illustrated in FIG. 7C.

The vehicle operation information auxiliary image IM3 having the first viewing angle (wide viewing angle) can be seen by users at any location, for example, a driver and a passenger. Accordingly, this mode can be the share mode (SM), as described above.

That is, the mode of the first light emitting area EA1 can be changed from the privacy mode (PM) to the share mode (SM) through the method described above.

The mode of each of the remaining light emitting areas can also be changed from the privacy mode (PM) to the share mode (SM), or changed from the share mode (SM) to the privacy mode (PM) through the same method as described above.

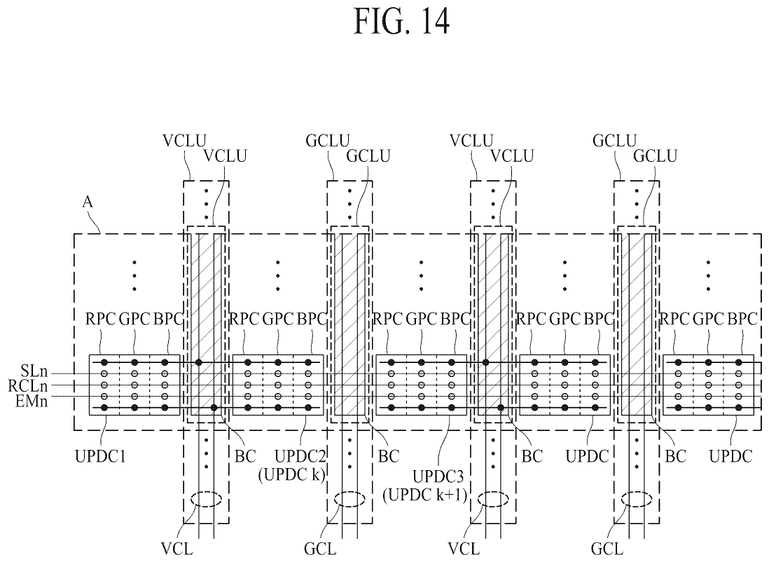

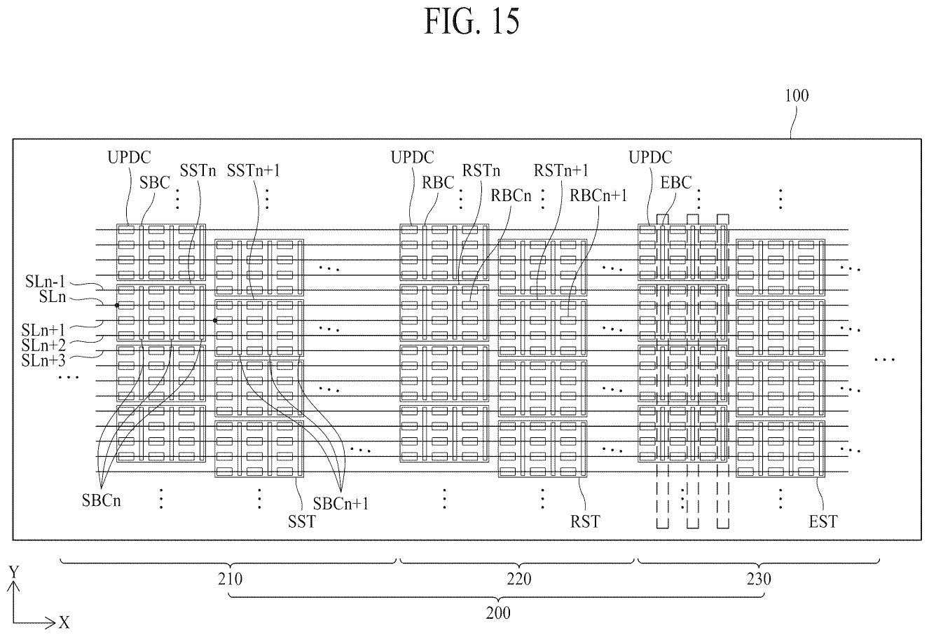

FIG. 14 is an exemplary diagram illustrating an area A illustrated in FIG. 1 according to an embodiment of the present disclosure, and FIG. 15 is an exemplary diagram illustrating a light emitting display panel applied to a light emitting display apparatus according to an embodiment of the present disclosure. In the following description, details which are the same as or similar to details described with reference to FIGS. 1 to 13 are omitted or will be briefly described.

First, a light emitting display apparatus according to the present disclosure can include a viewing angle control line unit VCLU including at least one viewing angle control line VCL provided between a first unit pixel driving circuit UPDC1 and a second unit pixel driving circuit UPDC2 which are provided along a nth (n is a natural number less than g) scan line SLn and a gate control line unit GLCU including a gate control line GCL provided between a kth (k is a natural number less than or equal to g) unit pixel driving circuit UPDCk and a k+1th unit pixel driving circuit UPDCk+2 which are provided along the nth scan line SLn).

For example, as illustrated in FIG. 14, when the unit pixel driving circuits UPDC are provided along the nth scan line SLn, the viewing angle control line unit VCLU can be provided between the first unit pixel driving circuit UPDC1 and the second unit pixel driving circuit UPDC2 adjacent to each other. At least one viewing angle control line VCL can be provided in the viewing angle control line unit VCLU. A viewing angle control signal VCS can be supplied to the viewing angle control line VCL.

The unit pixel driving circuit UPDC can be included in the unit pixel UP, and three subpixels SP can be included in the unit pixel UP. Each of the subpixels SP can include a subpixel driving circuit SPDC, a first light emitting device ED1, and a second light emitting device ED2.

The unit pixel driving circuit UPDC can include three subpixel driving circuits SPDCs configuring three subpixels SP.

In this case, areas in which light emitting devices corresponding to a first unit pixel driving circuit UPDC1 and light emitting devices corresponding to a second unit pixel driving circuit UPDC2 are provided can form one light emitting area.

Also, as illustrated in FIG. 14, when the unit pixel driving circuits UPDC are provided along the nth scan line SLn, a gate control line unit GCLU can be provided between the kth unit pixel driving circuit UPDCk and the k+1th unit pixel driving circuit UPDCk adjacent to each other, and gate control lines GCL can be provided in the gate control line unit GCLU. A gate control signal GCS can be supplied to the gate control line GCL.

At least one unit pixel driving circuit UPDC can be provided between the viewing angle control line unit VCLU and the gate control line unit GCLU adjacent to each other.

For example, as illustrated in FIG. 14, one unit pixel driving circuit UPDC can be provided between the viewing angle control line unit VCLU and the gate control line unit GCLU adjacent to each other.

However, two or more unit pixel driving circuits can be provided between the viewing angle control line unit VCLU and the gate control line unit GCLU adjacent to each other.

At least one viewing angle control line VCL can be connected to the first unit pixel driving circuit UPDC1 and the second unit pixel driving circuit UPDC2.

For example, as illustrated in FIG. 2, when the first viewing angle control line VCL1 and the second viewing angle control line VCL2 are connected to the subpixel SP, two viewing angle control lines VCL can be provided in each of the viewing angle control line units VCLU, as illustrated in FIG. 14.

However, as described above, when the first viewing angle control transistor Tvc1 and the second viewing angle control transistor Tvc2 provided in the subpixel SP are formed of different types of transistors, one viewing angle control line VCL can be connected to the subpixel SP. In this case, one viewing angle control line VCL can be provided in each of the viewing angle control lines units VCLU illustrated in FIG. 14.

The gate control lines GCL can be connected to the gate driver 200 provided in the viewing angle control line unit VCLU and the gate control line unit GCLU.

That is, transistors and capacitors configuring the gate driver 200 can be distributed and provided in the viewing angle control line unit VCLU and the gate control line unit GCLU.

For example, when the gate driver 200 includes branch circuits BC, each of the branch circuits BC can be provided in one of the viewing angle control line units VCLU and the gate control line units GCLU.

A structure in which the gate control lines GCL are connected to the gate driver 200 will be described in detail with reference to FIG. 18.

Next, the gate control lines GCL can be connected to the control driver 400 which generates the gate control signal GCS to be supplied to the gate control lines GCL.

For example, gate control lines GCL can be provided in the gate control line unit GCLU, and the gate control lines GCL can be connected to the control driver 400, as illustrated in FIG. 1. Particularly, the gate control lines GCL can be connected to the gate control signal generator 421 illustrated in FIG. 3.

The gate control signals GCS generated by the gate control signal generator 421 can be transmitted to the gate driver 200 through the gate control lines GCL.

At least one viewing angle control line can be connected to the control driver 400.

For example, at least one viewing angle control line VCL can be provided in the viewing angle control line unit VCLU, and the viewing angle control line VCL can be connected to the control driver 400, as illustrated in FIG. 1. Particularly, the viewing angle control line VCL can be connected to the viewing angle control signal generator 422 illustrated in FIG. 3.

The viewing angle control signal VCS generated by the viewing angle control signal generator 422 can be transmitted to the subpixels SP through the viewing angle control line VCL.

Next, in the above-described example, when one unit pixel driving circuit UPDC is provided between the viewing angle control line unit VCLU and the gate control line unit GCLU adjacent to each other, the k unit pixel driving circuit UPDCk can be the second unit pixel driving circuit UPDC2, and the k+1th unit pixel driving circuit UPDCk+1 can be a third unit pixel driving circuit UPDC3.

For example, at least one unit pixel driving circuit UPDC can be provided between the viewing angle control line unit VCLU and the gate control line unit GCLU adjacent to each other along the nth scan line SLn.

In this case, when one unit pixel driving circuit UPDC is provided between the viewing angle control line unit VCLU and the gate control line unit GCLU adjacent to each other along the nth scan line SLn, in the example described above, the kth unit pixel driving circuit UPDCk can be the second unit pixel driving circuit UPDC2, and the k+1th unit pixel driving circuit UPDCk+1 can be the third unit pixel driving circuit UPDC3.

Next, each of the first unit pixel driving circuit UPDC1 and the second unit pixel driving circuit UPDC2 can include at least three subpixel driving circuits.

The three subpixel driving circuits can include a red subpixel driving circuit RPC provided in the red subpixel RP, a green subpixel driving circuit GPC provided in the green subpixel GP, and a blue subpixel driving circuit BPC provided in the blue subpixel BP.

For example, as described above, each of the subpixels SP can include the subpixel driving circuit SPDC, the first light emitting device ED1, and the second light emitting device ED2, and the unit pixel UP can include three subpixels SP.

Therefore, the unit pixel UP can include three subpixel driving circuits SPDC, three first light emitting devices ED1, and three second light emitting devices ED2.

In this case, the three subpixel driving circuits SPDC included in the unit pixel UP can configure the unit pixel driving circuit UPDC.

That is, the unit pixel driving circuit UPDC can include three subpixel driving circuits SPDC.

Each of the at least three subpixel driving circuits SPDC can include a first viewing angle control transistor Tvc1 connected to the first viewing angle control line VCL1 provided in the viewing angle control line unit VCLU and a second viewing angle control transistor Tvc2 connected to the second viewing angle control line VCL2 provided in the viewing angle control line unit VCLU.

For example, the first viewing angle control line VCL1 provided in the viewing angle control line unit VCLU can be connected to the first viewing angle control transistor Tvc1 illustrated in FIG. 2, and a first viewing angle control signal VCS1 generated by the viewing angle control signal generator 422 can be transmitted to the gate of the first viewing angle control transistor Tvc1 through the first viewing angle control line VCL1.

The second viewing angle control line VCL2 provided in the viewing angle control line unit VCLU can be connected to the second viewing angle control transistor Tvc2 illustrated in FIG. 2, and a second viewing angle control signal VCS2 generated by the viewing angle control signal generator 422 can be transmitted to the gate of the second viewing angle control transistor Tvc2 through the second viewing angle control line VCL2.

Next, a first viewing angle of light output from a first light emitting unit LU1 driven by the first viewing angle control transistor Tvc1 and a second viewing angle of light output from a second light emitting unit LU2 driven by the second viewing angle control transistor Tvc2 can be different from each other.

For example, as described above, the shapes of the first lens LZ1 provided in the first light emitting unit LU1 and the second lens LZ2 provided in the second light emitting unit LU2 can be different from each other, and accordingly, an exit angle, that is, a viewing angle, of a light output through the first lens LZ1 can be different from a viewing angle of a light output through the second lens LZ2.

Next, the first viewing angle control transistor Tvc1 can be connected between the first light emitting unit LU1 and the driving transistor Tdr controlling the level of the current supplied to the first light emitting unit LU1 or the second light emitting unit LU2. Also, the second viewing angle control transistor Tvc can be connected between the driving transistor Tdr and the second light emitting unit LU2.

For example, as described above, the first light emitting unit LU1 can include the first light emitting device ED1 and the first lens LZ1, and the second light emitting unit LU2 can include the second light emitting device ED2 and the second lens LZ2.

Therefore, as illustrated in FIG. 2, the first viewing angle control transistor Tvc1 can be connected between the first light emitting device ED1 and the driving transistor Tdr, and the second viewing angle control transistor Tvc2 can be connected between the second light emitting device ED2 and the driving transistor Tdr.

Next, at least one viewing angle control line VCL can be connected to adjacent unit pixel driving circuits UPDC along at least one viewing angle control line VCL.

For example, in FIG. 14, only the first unit pixel driving circuit UPDC provided on the left side of the viewing angle control line VCL and the second unit pixel driving circuit UPDC provided on the right side of the viewing angle control line VCL are connected to the viewing angle control line VCL.

However, unit pixel driving circuits UPDC provided at an upper end and a lower end of the first unit pixel driving circuit UPDC1 along the viewing angle control line VCL and unit pixel driving circuits UPDC provided at an upper end and a lower end of the second unit pixel driving circuit UPDC2 along the viewing angle control line VCL can also be connected to the viewing angle control line VCL.

That is, the viewing angle control line VCL can be connected to unit pixel driving circuits UPDC provided along the viewing angle control line VCL.

In this case, unit pixels adjacent along the viewing angle control line VCL and including unit pixel driving circuits UPDC connected to the viewing angle control line VCL can form one light emitting area.

Also, in FIG. 14, the first unit pixel driving circuit UPDC1 provided on the left side of the viewing angle control line VCL and the second unit pixel driving circuit UPDC2 provided on the right side of the viewing angle control line VCL are connected to the viewing angle control line VCL, but at least two unit pixel driving circuits UPDC provided on the left side of the viewing angle control line VCL and at least two unit pixel driving circuits provided on the right side of the viewing angle control line VCL can be connected to the viewing angle control line VCL.

In this case, unit pixel driving circuits UPDC provided at an upper end and a lower end of the at least two unit pixel driving circuits UPDC provided on the left side of the viewing angle control line VCL and unit pixel driving circuits UPDC provided at an upper end and a lower end of the at least two unit pixel driving circuits UPDC provided on the right side of the viewing angle control line VCL can also be connected to the viewing angle control line VCL.

In this case, unit pixels which are adjacent along the viewing angle control line VCL and includes unit pixel driving circuits UPDC connected to the viewing angle control line VCL can form one light emitting area.

Accordingly, the number and arrangement positions of the unit pixel driving circuits UPDC connected to the viewing angle control line VCL can be variously changed. Accordingly, the size, shape, and position of the light emitting area can be variously changed.

Next, the viewing angle control line unit VCLU can further include at least one auxiliary gate control line connected to the gate driver 200.

For example, three gate control lines GCL can be provided in the gate control line unit GCLU.

In this case, an auxiliary gate control line can be further included in the viewing angle control line unit VCLU in order to equalize the number of lines provided in the gate control line unit GCLU and the number of lines provided in the viewing angle control line unit VCLU.

The auxiliary gate control line can be connected to the gate driver 200 and can transmit the gate control signal GCL transmitted from the control driver 400 to the gate driver 200. Accordingly, the auxiliary gate control line can substantially perform the function of the gate control line GCL.

For example, in order to minimize or at least reduce the parasitic capacitance of a Q node which affects the bootstrap driving of the gate driver 200, the gate control line GCL which can affect the parasitic capacitance of the Q node can be provided in the viewing angle control line unit VCLU. In this case, the gate control line GCL provided in the viewing angle control line unit VCLU can be the auxiliary gate control line.

However, the number of lines provided in the gate control line unit GCLU and the number of lines provided in the viewing angle control line unit VCLU need not necessarily be the same. Moreover, the number of lines provided in the gate control line units GCLU does not necessarily have to be the same, and the number of lines provided in the viewing angle control line units VCLU does not necessarily have to be the same.

Next, the viewing angle control line unit VCLU can further include branch circuits BC connected to the gate control lines GCL.

The branch circuit BC can include at least one transistor among transistors configuring the gate driver 200.

The viewing angle control line unit VCLU can include at least two branch circuits BC.

That is, the transistors configuring the gate driver 200 can be distributed and disposed in the branch circuits BC provided in the viewing angle control line units VCLU.

Next, the gate control line unit GCLU can further include branch circuits BC connected to the gate control lines GCL.

For example, as described above, the transistors configuring the gate driver 200 can be distributed and disposed in branch circuits BC provided in the viewing angle control line units VCLUs and branch circuits BC provided in the gate control line units GCLU.

Accordingly, the structure of the viewing angle control line unit VCLU can be similar to the structure of the gate control line unit GCLU.

Next, each of the first unit pixel driving circuit UPDC1 and the second unit pixel driving circuit UPDC2 can include at least three subpixel driving circuits.

In this case, the viewing angle control line unit VCLU can overlap a light emitting device ED connected to any one of subpixel driving circuits SPDC provided in the first unit pixel driving circuit PUDC1 and the second unit pixel driving circuit UPDC2.

For example, light emitting devices ED corresponding to the unit pixel driving circuit UPDC may not be configured to completely overlap the unit pixel driving circuit UPDC.

Moreover, viewing angle control lines VCL and light emitting devices ED can be provided on different layers, and unit pixel driving circuit UPDC and light emitting devices ED can be provided on different layers.

Accordingly, at least one of the light emitting devices ED corresponding to the unit pixel driving circuit UPDC can be provided in the viewing angle control line unit VCLU.

Next, the viewing angle control line unit VCLU can further include a metal blocking layer provided between at least one viewing angle control line VCL and a light emitting device ED.

For example, when a viewing angle control line VCL and a light emitting device ED overlap, parasitic capacitance can occur between the viewing angle control line VCL and an anode configuring the light emitting device ED.

Therefore, to prevent parasitic capacitance, the metal blocking layer can be provided between at least one viewing angle control line VCL and the light emitting device ED.

Next, each of the kth unit pixel driving circuit UPDCk and the k+1th unit pixel driving circuit UPDCk+1 can include at least three subpixel driving circuits SPDC.

In this case, the gate control line unit GCLU can overlap a light emitting device ED connected to any one of subpixel driving circuits SPDC provided in the kth unit pixel driving circuit UPDCk and the k+1th unit pixel driving circuit UPDCk+1.

For example, light emitting devices ED corresponding to the unit pixel driving circuit UPDC may not be configured to completely overlap the unit pixel driving circuit UPDC.

Moreover, gate control lines GCL and light emitting devices ED can be provided on different layers, and unit pixel driving circuit UPDC and light emitting devices ED can be provided on different layers.

Therefore, at least one of the light emitting devices ED corresponding to the unit pixel driving circuit UPDC can be provided in the gate control line unit GCLU.

As described above, at least one of the light emitting devices ED connected to the unit pixel driving circuit UPDC adjacent to the viewing angle control line unit VCLU can be provided in the viewing angle control line unit VCLU, and at least one of the light emitting devices ED connected to the unit pixel driving circuit UPDC adjacent to the gate control line unit GCLU can be provided in the gate control line unit GCLU.

Therefore, the structure of the gate control line unit GCLU can be similar to the structure of the viewing angle control line unit VCLU.

Further, the gate control line unit GCLU can further include a metal blocking layer provided between at least one gate control line GCL and the light emitting device ED.

For example, when a gate control line GCL and a light emitting device ED overlap, parasitic capacitance can be generated between an anode configuring the light emitting device ED and the gate control line GCL.

Therefore, to prevent parasitic capacitance, the metal blocking layer can be provided between at least one gate control line GCL and the light emitting device ED.

Therefore, the structure of the gate control line unit GCLU can be similar to the structure of the viewing angle control line unit VCLU.

According to the light emitting display apparatus according to the present disclosure as described above, the viewing angle control line unit VCLU and the gate control line unit GCLU having the same or similar structure can be repeatedly provided in the light emitting display panel 100. Also, the subpixel driving circuit SPDC and the light emitting devices ED having the same or similar structure can be repeatedly provided in the light emitting display panel 100.

Accordingly, design of the light emitting display panel can be simplified, and manufacturing of the light emitting display panel can be simplified.

Next, the gate driver 200 can include the scan driver 210 connected to switching transistors Tsw1 provided in the unit pixel driving circuits PDC, the reference driver 220 connected to the reference transistors Tsw2a and Tsw2b provided in the unit pixel driving circuits PDC, and the emission driver 230 connected to the emission transistors Tsw4a and Tsw4b provided in the unit pixel driving circuits PDC, as illustrated in FIGS. 1, 2, 4A and 15.

The scan driver 210 can include scan stages SST, as illustrated in FIGS. 4A and 15.

Among the scan stages, a nth scan stage SSTn connected to a nth scan line SLn can include nth scan branch circuits SBCn, and each of the nth scan branch circuits SBCn can include at least one transistor provided in the scan driver 210.

In this case, each of the nth scan branch circuits SBCn can be provided in one of the viewing angle control line units VCLU and the gate control line units GCLU adjacent along the nth scan line SLn, as illustrated in FIG. 15.

For example, as illustrated in FIG. 15, when the nth scan stage SSTn includes three nth scan branch circuits SBCn, the three nth scan branch circuits SBCn can be provided along the nth scan line SLn.

The nth scan stage SSTn can generate an nth scan pulse and output it to the nth scan line SLn connected to the nth scan stage SSTn.

Each of the three nth scan branch circuits SBCn can be provided in any one of at least one viewing angle control line unit VCLU and at least one gate control line unit GCLU overlapping the nth scan stage SSTn.

Next, the nth scan line SLn and at least two scan lines adjacent to the nth scan line SLn can overlap each of the nth scan branch circuits SBCn configuring the nth scan stage SSTn.

For example, in the light emitting display panel illustrated in FIG. 15, each of the nth scan branch circuits SBCn is provided in the viewing angle control line unit VCLU or the gate control line unit GCLU, and overlaps four scan lines SLn−1, SLn, SLn+1, and SLn+2.

In this case, the four scan lines SLn−1, SLn, SLn+1, and SLn+2 which the nth scan branch circuits SBCn overlap are the same.

However, the nth scan branch circuits SBCn can be provided in the viewing angle control line units VCLU or the gate control line units GCLU to overlap one, two, or three scan lines, and can be provided in the viewing angle control line units VCLU or the gate control line unit GCLU to overlap five or more scan lines.

Next, among the scan stages SST, a n+1th scan stage SSTn+1 connected to the n+1th scan line SLn+1 can include n+1th scan branch circuits SBCn+1, and each of the n+1th scan branch circuits SBCn+1 can include at least one transistor.

In this case, each of the n+1th scan branch circuits SBCn+1 can be provided in one of the viewing angle control line units VCLU and the gate control line units GCLU adjacent along the n+1th scan line SLn+1.

For example, the n+1th scan stage SSTn+1 and the n+1th scan branch circuit SBCn+1 can be provided on the light emitting display panel 100 in a form similar to the nth scan stage SSTn and the nth scan branch circuit SBCn described with reference to FIG. 15.

In this case, at least one of the at least three scan lines SL overlapping the nth scan branch circuits SBCn may not overlap the n+1th scan branch circuits SBCn+1.

For example, as illustrated in FIG. 15, when the nth scan branch circuits SBCn overlap the four scan lines SLn−1, SLn, SLn+1, and SLn+2 and the n+1th scan branch circuits SBCn+1 overlap the four scan lines SLn, SLn+1, SLn+2, and SLn+3, at least one of the four scan lines SLn−1, SLn, SLn+1, and SLn+2 overlapping the nth scan branch circuits SBCn may not overlap the n+1th scan branch circuits SBCn+1.

In the above example, the n−1th scan line SLn−1 among the four scan lines SLn−1, SLn, SLn+1, and SLn+2 overlapping the nth scan branch circuits SBCn may not overlap the n+1th scan branch circuits SBCn+1.

For example, the scan stages SST can be provided on the light emitting display panel 100 to misalign along the scan lines SL, as illustrated in FIG. 15.

To provide an additional description, the scan stages SST can be provided on the light emitting display panel 100 in the form of steps along the scan lines SL.

Next, along the first direction X parallel to the nth scan line SLn, another scan stage SST configuring the scan driver 210 can be provided on the left or right side of the nth scan stage SSTn. Also, along the second direction Y different from the first direction X, another scan stage SST configuring the scan driver 210 can be provided on the upper or lower side of the nth scan stage SSTn.

For example, the scan stages SST configuring the gate driver 210 can be provided along the first direction X and can be provided along the second direction Y, as illustrated in FIG. 15.

In this case, the scan stages SST provided along the second direction Y can be provided in a line.

However, the scan stages SST provided along the first direction X may not be arranged in a line, but can be arranged misaligned, as described above.

For example, the scan stages SST provided along the first direction X can be provided at positions moved in the second direction Y by one scan line SL, as illustrated in FIG. 15.

By the above-described structure, each of the scan stages SST configuring the scan driver 210 can be connected to one scan line SL.

Next, as described above, the gate driver 200 can include the scan driver 210, the reference driver 220, and the emission driver 230.

That is, the gate driver 200 can include the reference driver 220 connected to the reference transistors Tsw2a and Tsw2b provided in the unit pixel driving circuits UPDC.

In this case, the reference driver 220 can include reference stages RST. Among the reference stages RST, a nth reference stage RSTn connected to subpixels connected to a nth scan line SLn can include nth reference branch circuits RBCn. Each of the nth reference branch circuits RBCn can include at least one transistor. Each of the nth reference branch circuits RBCn can be provided in one of viewing angle control line units VCLU and gate control line units VCLU adjacent along the nth scan line.

The arrangement structure of the reference stages RST configuring the reference driver 220 and the arrangement structure of the reference branch circuits RBC configuring the reference stage RST can be the same as or similar to the arrangement structure of the scan stages SST and the arrangement structure of the scan branch circuits SBC described above.

For example, as illustrated in FIG. 15, when the nth reference stage RSTn includes three nth reference branch circuits RBCn, the three nth reference branch circuits RBCn can be provided along the nth scan line SLn.

The nth reference stage RSTn can generate a nth reference pulse and output it to a nth reference control line RCLn connected to the nth reference stage SSTn.

Each of the three nth reference branch circuits RBCn can be provided in any one of at least one viewing angle control line unit VCLU and at least one gate control line unit GCLU overlapping the nth reference stage RSTn.

The nth reference control line RCLn and at least two reference control lines adjacent to the nth reference control line RCLn can overlap each of nth reference branch circuits RBCn configuring the nth reference stage RSTn.

Among the reference stages RST, a n+1th reference stages RSTn+1 connected to a n+1th reference control line can include n+1th reference branch circuits RBCn+1, and each of the n+1th reference branch circuits RBCn+1 can include at least one transistor.

Each of the n+1th reference branch circuits RBCn+1 can be provided in one of viewing angle control line units VCLU and gate control line units GCLU adjacent along the n+1th reference control line.

At least one of the at least three reference control lines RCLs overlapping the nth reference branch circuits RBCn may not overlap a n+1th reference branch circuits RBCn+1.

Along the first direction X parallel to the nth reference control line RCLn, another reference stage RST configuring the reference driver 220 can be provided on the left or right side of the nth reference stage RSTn, and along the second direction Y different from the first direction X, another reference stage RST configuring the reference driver 220 can be provided on the upper or lower side of the nth reference stage RSTn.

The reference stages RST can be provided on the light emitting display panel 100 to be misaligned along the scan lines SL, as illustrated in FIG. 15.

To provide an additional description, the reference stages RST can be provided on the light emitting display panel 100 in the form of steps along the scan lines SL.

By the above-described structure, each of the reference stages RST configuring the reference driver 220 can be connected to one reference control line RCL.

Next, the reference driver 220 can be provided on the left or right side of the scan driver 210 along the first direction parallel to the nth scan line SLn.

For example, as illustrated in FIG. 15, the reference driver 220 can be provided on the right side of the scan driver 210 along the first direction X parallel to the nth scan line SLn.

Finally, the gate driver 200 can include the emission driver 230 connected to the emission transistors Tsw4a and Tsw4b provided in the unit pixel driving circuits PDC.

The arrangement structure of emission stages EST configuring the emission driver 230 and the arrangement structure of emission branch circuits EBC configuring the emission stage EST can be the same as or similar to the arrangement structure of the scan stages SST and the arrangement structure of the scan branch circuits SBC described above.

The emission driver 230 can be provided on the left or right side of the reference driver 220 along the first direction parallel to the nth scan line SLn.

For example, as illustrated in FIG. 15, the emission driver 230 can be provided on the right side of the reference driver 220 along the first direction X parallel to the nth scan line SLn.

However, the arrangement positions of the scan driver 210, the reference driver 220, and the emission driver 230 are not limited to the arrangement positions illustrated in FIG. 15.

For example, the scan driver 210 can be provided in a central portion of the light emitting display panel. In this case, the reference driver 220 can be provided in a left side of the scan driver 210, and the emission driver 2300 can be provided in a right side of the scan driver 210.

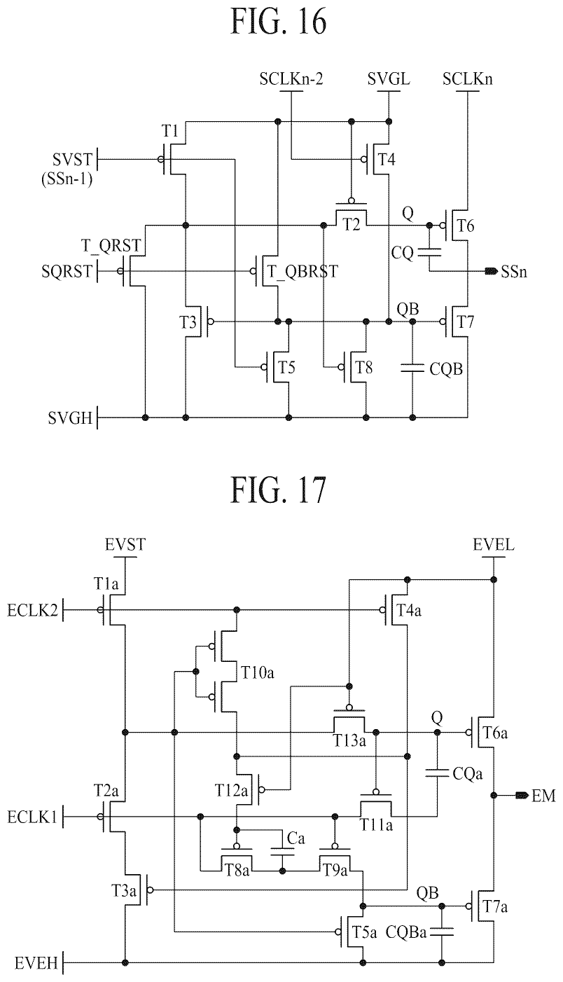

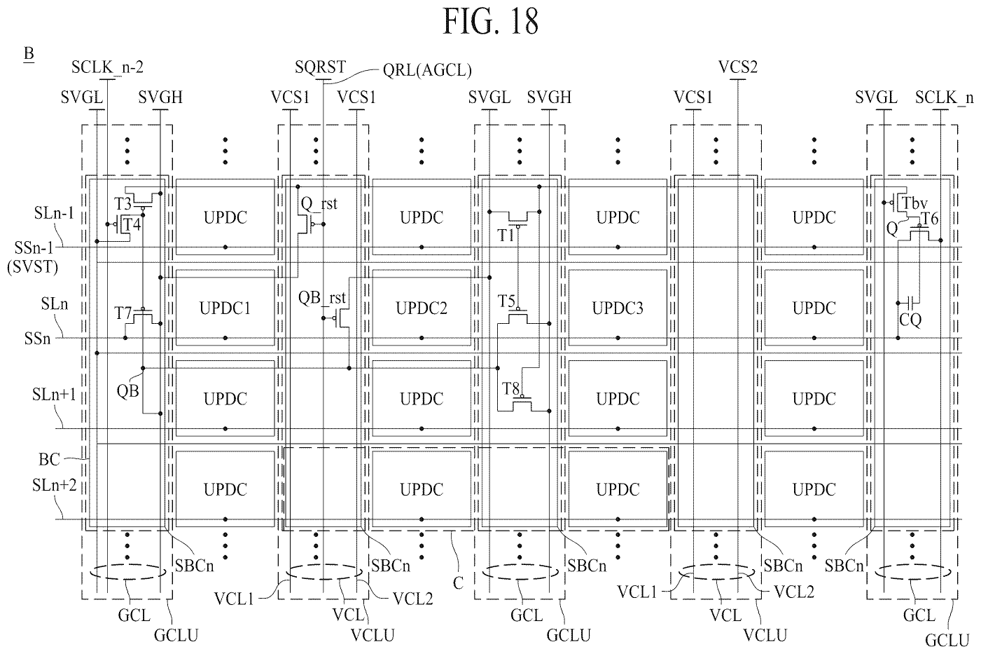

FIG. 16 is an exemplary diagram illustrating a configuration of a scan stage applied to a light emitting display apparatus according to an embodiment of the present disclosure, and FIG. 17 is an exemplary diagram illustrating a configuration of an emission stage applied to a light emitting display apparatus according to an embodiment of the present disclosure.

As described above, the gate driver 200 can include the scan driver 210, the reference driver 220, and the emission driver 230.

First, the scan driver 210 can include scan stages SST, as described with reference to FIGS. 4A and 15.

The scan stage SST can have a structure as illustrated in FIG. 16. Particularly, the nth scan stage SSTn is illustrated in FIG. 16.

For example, the nth scan stage SSTn can include first to 8th scan transistors T1 to T8, a scan Q node reset transistor T_QRST, a scan QB node reset transistor T_QBRST, a scan Q node capacitor CQ, and a scan QB node capacitor CQB.

A scan start signal SVST can be input to a gate of the first scan transistor T1. The scan start signal SVST can be transmitted from the control driver 400, or can be a scan signal SSn−1 output from a n−1th scan stage.

The second scan transistor T2 can be connected between the scan Q node reset transistor T_QRST and the 6th scan transistor T6. A second scan voltage SVGL can be supplied to a gate of the second scan transistor T2.

The third scan transistor T3 can be connected between a terminal to which a first scan voltage SVGH is supplied and the first scan transistor T1.

The fourth scan transistor T4 can be connected between a terminal to which the second scan voltage SVGL is supplied and a QB node QB. The fourth scan transistor T4 can be turned on or off by a n−2th scan clock SCLKn−2.

The 5th scan transistor T5 can be connected between the terminal to which the first scan voltage SVGH is supplied and the QB node QB.

The 6th scan transistor T6 can be turned on by a signal supplied to the Q node Q to output a nth scan clock SCLKn to a nth scan line SLn. The nth scan clock SCLKn can be an nth scan pulse configuring the nth scan signal SSn.

The 7th scan transistor T7 can be turned on by a signal supplied to the QB node QB to output the first scan voltage SVGH to the nth scan line SLn. The first scan voltage SVGH can be an nth scan-off signal configuring the nth scan signal SSn.

The 8th scan transistor T8 can be connected between the terminal to which the first scan voltage SVGH is supplied and the QB node QB.

A scan Q node reset signal SQRST capable of resetting the Q node Q can be supplied to the gate of the scan Q node reset transistor T_QRS. The signal capable of resetting the Q node Q can be the first scan voltage SVGH.

The scan QB node reset transistor T_QBRST can be connected between the terminal to which the second scan voltage SVGL is supplied and the QB node QB.

The scan Q node capacitor CQ can be connected between the 6th scan transistor T6 and the nth scan line SLn.

The scan QB node capacitor CQB can be connected between the terminal to which the first scan voltage SVGH is supplied and the gate of the 7th scan transistor T7.

The transistors configuring the scan stage SST can be formed of P-type transistors, as illustrated in FIG. 16.

However, the structure of the scan stage SST is not limited to the structure illustrated in FIG. 16, and thus can be changed in various shapes.

Next, the reference driver 220 can include reference stages RST, as described with reference to FIGS. 4B and 15.

The structure of the reference stage RST can be the same as or similar to the structure of the scan stage SST illustrated in FIG. 16.

In this case, signals supplied to the reference stage RST (e.g., a first reference voltage, a second reference voltage, a nth reference clock, a n−2th reference clock, a reference start signal, a reference Q node reset signal) can be the same as or similar to signals supplied to the scan stage SST (e.g., the first scan voltage SVGH, the second scan voltage SVGL, the nth scan clock SCLKn, the n−2th scan clock SCLKn−2, the scan start signal SVST, the scan Q node reset signal SQRST).

However, the structure of the reference stage RST does not necessarily have to be the same as the structure of the scan stage SST illustrated in FIG. 16, and can be formed in a different form.

Finally, the emission driver 230 can include emission stages EST, as described with reference to FIGS. 4C and 15.

The emission stage EST can have a structure as illustrated in FIG. 17.

For example, the emission stage EST can include first to 13th emission scan transistors T1a to T13a, an emission capacitor Ca, an emission Q node capacitor CQa, and an emission QB node capacitor CQBa.

A second emission clock ECLK2 can be input to a gate of the first emission transistor T1a, an emission start signal EVST can be input to a first terminal of the first emission transistor T1a, and a second terminal of the first emission transistor T1a can be connected to the second emission transistor T2a.

A first emission clock ECLK1 can be input to a gate of the second emission transistor T2a, a first terminal of the second emission transistor T2a can be connected to the second terminal of the first emission transistor T1a, and a second terminal of the second emission transistor T2a can be connected to a first terminal of the third emission transistor T3a.

The third emission transistor T3a can be connected between a terminal to which a first emission voltage EVEH is supplied and the second emission transistor T2a.

The fourth emission transistor T4a can be connected between a terminal to which a second emission voltage EVEL is supplied and a gate of the third emission transistor T3a.

The fifth emission transistor T5a can be connected between a terminal to which the first emission voltage EVEH is supplied and a gate of the seventh emission transistor T7a.

The sixth emission transistor Toa can be turned on by a signal supplied to the Q node Q to output the second emission voltage EVEL to the emission line EL. The second emission voltage EVEL can be an emission pulse configuring the emission signal EM.

The seventh emission transistor T7a can be connected between the terminal to which the first emission voltage EVEH is supplied and the emission line EL. The first emission voltage EVEH can be an emission-off signal configuring the emission signal EM.

The eighth emission transistor Ta can be connected between the gate of the second emission transistor T2a and the ninth emission transistor T9a.

The ninth emission transistor T9a can be connected between a second terminal of the eighth emission transistor T8a and the fifth emission transistor T5a.

The tenth emission transistor T10 can be connected between the gate of the first emission transistor T1a and the twelfth emission transistor T12a.

The thirteenth emission transistor T13a can be connected between the second emission transistor T2a and a gate of the sixth emission transistor T6a.

The emission capacitor Ca can be connected between a gate of the eighth emission transistor T8a and the second terminal of the eighth emission transistor T8a.

The emission Q node capacitor CQa can be connected between the Q node Q, which is a gate of the sixth emission transistor T6a, and the eleventh emission transistor T11a.

The emission QB node capacitor CQBa can be connected between the QB node QB, which is a gate of the seventh emission transistor T7a, and the terminal to which the first emission voltage EVEH is supplied.

The transistors configuring the emission stage EST can be formed of P-type transistors, as illustrated in FIG. 17.

However, the structure of the emission stage EST is not limited to the structure illustrated in FIG. 17, and thus can be changed in various forms.

FIG. 18 is an exemplary diagram illustrating an area B illustrated in FIG. 1. For example, 16 unit pixels UPDC provided in the area B illustrated in FIG. 1, three gate control line units GCLUs, and two viewing angle control line units VCLU are illustrated in FIG. 18.

In this case, five nth scan branch circuits SBCn illustrated in FIG. 18 can configure, for example, the nth scan stage SSTn illustrated in FIG. 16.

To provide an additional description, FIG. 18 illustrates a portion of an area in which the scan driver 210 is provided, and particularly, illustrates an area in which any one of the scan stages SST configuring the scan driver 210 is provided. As described above, the scan stage SST can include scan branch circuits SBC.

Therefore, nth scan branch circuits SBCn configuring the nth scan stage SSTn are illustrated in FIG. 18.

As described above, each of the scan branch circuits SBC can be provided in one of the gate control line units GCLU and the viewing angle control line units VCLU.

In this case, five scan branch circuits SBC configuring the nth scan stage SSTn illustrated in FIG. 16 are illustrated in FIG. 18. That is, the transistors configuring the nth scan stage SSTn illustrated in FIG. 16 can be distributed and disposed in three gate control line units GCLUs and two viewing angle control lines VCLUs, as illustrated in FIG. 18.

However, the number of scan branch circuits SBC configuring the nth scan stage SSTn can be variously changed.

In the following descriptions, details which are the same as or similar to details described with reference to FIGS. 1 to 17 are omitted or will be briefly described.

First, a light emitting display apparatus according to the present disclosure can include viewing angle control line units VCLU and gate control line units GCLU.

The viewing angle control line units VCLU and the gate control line units GCLU can be alternately provided on the light emitting display panel 100 along the scan line SL.

At least one unit pixel driving circuit UPDC can be provided between the viewing angle control line unit VCLU and the gate control line unit GCLU, which are adjacent to each other. For example, as illustrated in FIG. 18, one unit pixel driving circuit UPC can be provided between the viewing angle control line unit VCLU and the gate control line unit GCLU.

The viewing angle control line VCL can be connected to a unit pixel driving circuit UPDC adjacent to the viewing angle control line VCL.

Gate control lines GCL can be connected to the gate driver 200 provided in the viewing angle control line unit VCLU and the gate control line unit GCLU, and particularly, can be connected to branch circuits BC provided in the viewing angle control line unit VCLU and the gate control line unit GCLU.

Next, the gate control lines GCL can be connected to the control driver 400 which generates gate control signal GCS to be supplied to the gate control lines GCL.

At least one viewing angle control line can be connected to the control driver 400.

Next, the unit pixel driving circuit UPDC can include at least three subpixel driving circuits SPDC.

Each of the at least three subpixel driving circuits SPDC can include a first viewing angle control transistor Tvc1 connected to the first viewing angle control line VCL1 provided in the viewing angle control line unit VCLU and a second viewing angle control transistor Tvc2 connected to the second viewing angle control line VCL2 provided in the viewing angle control line unit VCLU.

Next, the viewing angle control line unit VCLU can further include at least one auxiliary gate control line connected to the gate driver 200.

For example, in FIG. 18, the scan Q node reset signal SQRST described with reference to FIG. 16 can be transmitted to a scan Q node reset signal line QRL included in the viewing angle control line unit VCLU.

In this case, the scan Q node reset signal line QRL can function as the gate control line GCL, and can be provided in the viewing angle control line unit VCLU.

Therefore, the scan Q node reset signal line QRL can be an auxiliary gate control line AGCL.

Finally, the viewing angle control line unit VCLU can further include branch circuits BC connected to the gate control lines GCL, and the gate control line GCLU can further include branch circuits BC connected to the gate control lines GCL.

For example, the branch circuits illustrated in FIG. 18 are scan branch circuits SBC configuring the scan driver 210, and each of the scan branch circuits SBC can be provided in one of the viewing angle control line units VCLU and the gate control line units GCLU.

At least one scan branch circuit SBC can be provided in one viewing angle control line unit VCLU, along the viewing angle control line VCL. Also, at least one scan branch circuit SBC can be provided in one gate control line unit GCLU, along the gate control line GCL.

In this case, the scan branch circuits SBC provided in one viewing angle control line unit VCLU can configure different scan stages SST, and the scan branch circuits SBC provided in one gate control line unit GCLU can configure different scan stages SST.

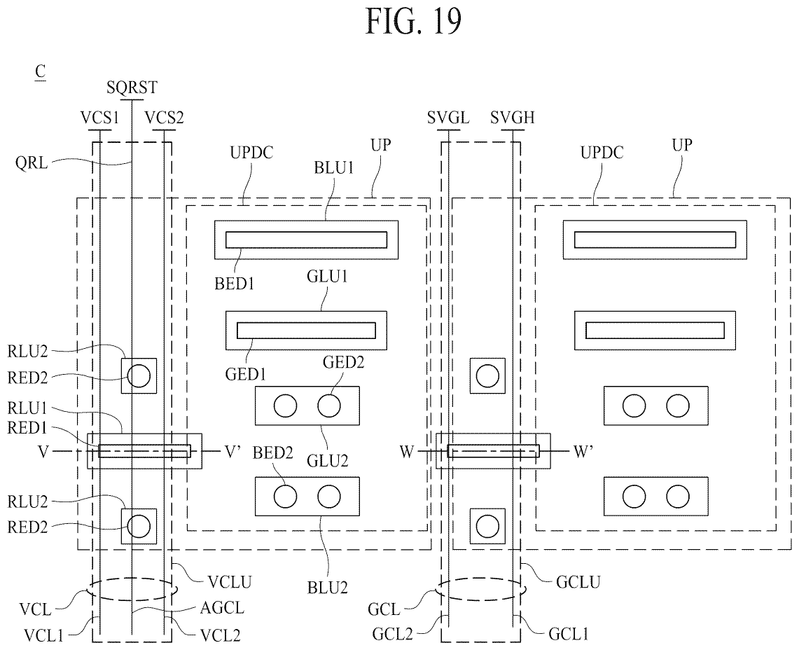

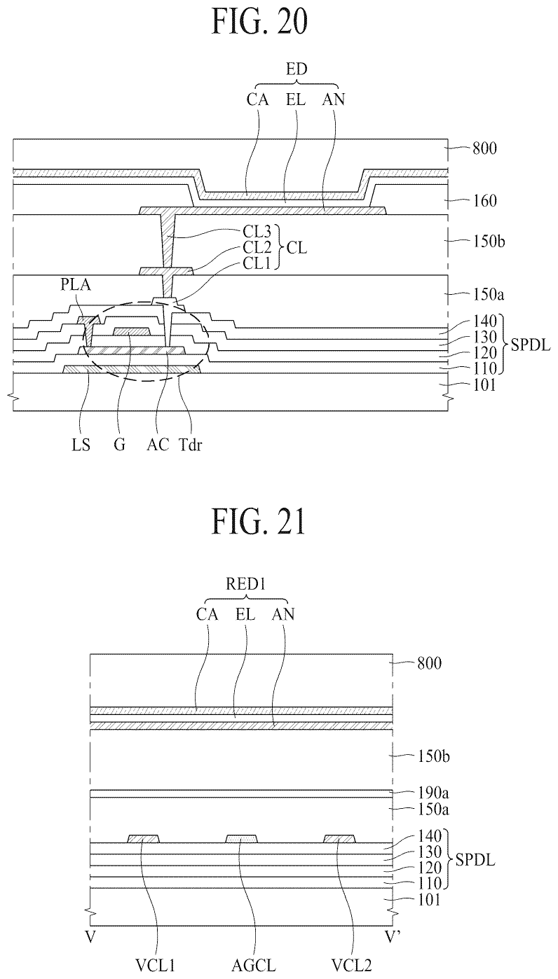

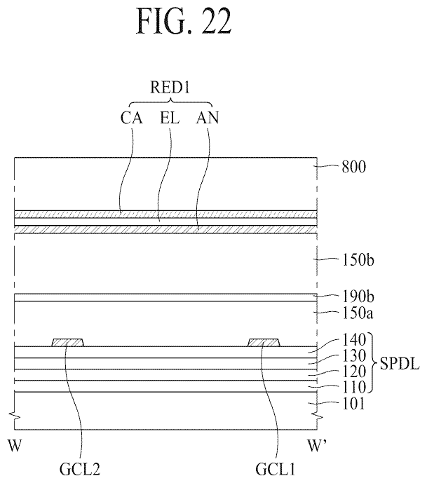

FIG. 19 is an exemplary diagram illustrating an area C illustrated in FIG. 18, FIG. 20 is an exemplary diagram illustrating a cross-sectional surface of a light emitting display panel applied to a light emitting display apparatus according to an embodiment of the present disclosure, FIG. 21 is an exemplary diagram illustrating a cross-sectional surface taken along line V-V′ illustrated in FIG. 19, and FIG. 22 is an exemplary diagram illustrating a cross-sectional surface taken along a line W-W′ illustrated in FIG. 19.

First, as described above, the unit pixel driving circuit UPDC can be included in the unit pixel UP, and three subpixels SP can be included in the unit pixel UP. Each of the subpixels SP can include the subpixel driving circuit SPDC, the first light emitting device ED1, and the second light emitting device ED2.

Therefore, the unit pixel driving circuit UPDC can include three subpixel driving circuits SPDC configuring the three subpixels SP.

The unit pixel driving circuit UPDC can be provided between the viewing angle control line unit VCLU and the gate control line unit GCLU, as illustrated in FIG. 19.

In this case, some of the light emitting devices ED configuring the three subpixels SP can be provided between the viewing angle control line unit VCLU and the gate control line unit GCLU, and can overlap the unit pixel driving circuit UPDC.

The remaining light emitting devices ED among the light emitting devices ED configuring the three subpixels SP can overlap either the viewing angle control line unit VCLU or the gate control line unit GCLU.

For example, when the three subpixels SP, as illustrated in FIG. 10, include the red subpixel RP, the green subpixel GP, and the blue subpixel BP, the red subpixel RP can include a red first light emitting unit RLU1 and a red second light emitting unit RLU2, the green subpixel GP can include a green first light emitting unit GLU1 and a green second light emitting unit GLU2, and the blue subpixel BP can include a blue first light emitting unit BLU1 and a blue second light emitting unit BLU2, as illustrated in FIG. 19.

The red first light emitting unit RLU1 can include at least one red first light emitting device RED1, and the red second light emitting unit RLU2 can include at least one red second light emitting device RED2.

The green first light emitting unit GLU1 can include at least one green first light emitting device GED1, and the green second light emitting unit GLU2 can include at least one green second light emitting device GED2.

The blue first light emitting unit BLU1 can include at least one blue first light emitting device BED1, and the blue second light emitting unit BLU2 can include at least one blue second light emitting device BED2.

For example, a red first light emitting unit RULU1 including one red first light emitting device RED1, a red second light emitting unit RLU2 including two red second light emitting devices RED2, a green first light emitting unit GLU1 including one green first light emitting device GED1, a green second light emitting unit GLU2 including two green second light emitting devices GED2, a blue first light emitting unit BLU1 including one blue first light emitting device BED1, and a blue second light emitting unit BLU2 including two blue second light emitting devices BED2 are illustrated in FIG. 19.

In this case, as described above, some of the light emitting devices ED configuring the three subpixels SP can be provided between the viewing angle control line unit VCLU and the gate control line unit GCLU, and the remaining light emitting devices ED can overlap either the viewing angle control line unit VCLU or the gate control line unit GCLU.

For example, as illustrated in FIG. 19, one green first light emitting device GED1, two green second light emitting devices GED2, one blue first light emitting device BED1, and two blue second light emitting devices BED2 can be provided between the viewing angle control line unit VCLU and the gate control line unit GCLU, and can overlap the unit pixel driving circuit UPDC.

In this case, one red first light emitting device RED1 and two red second light emitting devices RED2 can be provided in the viewing angle control line unit VCLU, or can be provided in the gate control line unit GCLU.

By the above-described structure, the entire surface of the light emitting display panel 100 can be covered with the light emitting devices ED.

Next, the viewing angle control line unit VCLU can further include a metal blocking layer provided between at least one viewing angle control line VCL and the light emitting device ED.

For example, as illustrated in FIGS. 19 and 20, when the first viewing angle control line VCL1 and the second viewing angle control line VCL2 overlap one red first light emitting device RED1 and two red second light emitting devices RED2, parasitic capacitance can be generated between anodes configuring the light emitting devices RED1 and RED2 and the viewing angle control lines VCL1 and VCL2. In this case, if the auxiliary gate control line AGCL is further provided in the viewing angle control line unit VCLU, parasitic capacitance can also be generated between the auxiliary gate control line AGCL and the anodes configuring the light emitting devices RED1 and RED2.

Therefore, to prevent or at least reduce the parasitic capacitance, a metal blocking layer 190a can be provided between at least one viewing angle control line VCL and the light emitting device ED.

For example, a light emitting display panel 100 applied to the light emitting display apparatus according to an embodiment of the present disclosure can include a substrate 101, a subpixel driving circuit layer SPDL provided on an upper end of the substrate 101, a first planarization layer 150a provided on an upper end of the subpixel driving circuit layer SPDL to cover the subpixel driving circuit layer SPDL, a second planarization layer 150b provided on an upper end of the first planarization layer 150a, an anode AN provided on an upper end of the anode AN, a light emitting layer EL provided on an upper end of the light emitting layer EL, a cathode CA provided on an upper end of the light emitting layer EL, and an encapsulation layer 107 covering the cathode CA provided on the upper end of the light emitting layer EL, as illustrated in FIG. 20.

Here, the light emitting device ED can include an anode AN, a light emitting layer ED, and a cathode CA. The light emitting device ED can be any one of the red first light emitting device RED1, the red second light emitting device RED2, the green first light emitting device GED1, the green second light emitting device GED2, the blue first light emitting device BED1, and the blue second light emitting device BED2.

The subpixel driving circuit layer SPDL can include, for example, a buffer layer 110, a gate insulation layer 120, an interlayer insulation layer 130, and a passivation layer 140.

The driving transistor Tdr connected to the light emitting device ED can include an active AC formed of a semiconductor, a gate G provided on the gate insulation layer 120 covering the active AC, an interlayer insulation layer 130 covering the gate G, a first voltage supply line PLA provided on the interlayer insulation layer 130 and connected to a first terminal of the active AC, a passivation layer 140 covering the first voltage supply line PLA, and a connection line CL connecting a second terminal of the active AC with the anode AN. A light blocking layer LS can be provided on the substrate 101 to overlap the active AC, and the light blocking layer LS can be covered by the buffer layer 110.

In this case, the connection line CL can include a first connection line CL1 connected to a second terminal of the active AC through a first contact hole provided in the gate insulation layer 120, the interlayer insulation layer 130, and the passivation layer 140, a second connection line CL2 connected to the first connection line CL1 through a second contact hole provided in the first planarization layer 150a, and a third connection line CL3 connected to the second connection line CL2 through a third contact hole provided in the second planarization layer 150b. The third connection line CL3 can be connected to the anode AN.

In this case, to prevent parasitic capacitance, the metal blocking layer 190a provided between the viewing angle control line VCL and the light emitting device ED can be provided on an upper end of the first planarization layer 150a and can be covered by the second planarization layer 150b, as illustrated in FIG. 21.

The metal blocking layer 190a can be provided on the first planarization layer 150a by using any one of various metal lines provided in the light emitting display panel 100.

For example, the metal blocking layer 190a can be a line connected to the cathode CA. In this case, the second voltage ELVSS can be supplied to the metal blocking layer 190a.

By the metal blocking layer 190a supplied with the second voltage ELVSS, parasitic capacitance may not be formed between the viewing angle control lines VCL1 and VCL2 and the light emitting device ED and parasitic capacitance may not be formed between the auxiliary gate control line AGCL and the light emitting device ED.

Accordingly, in the light emitting device ED, light corresponding to the data voltage Vdata can be normally output.

Finally, the gate control line unit GCLU can further include a metal blocking layer 190b provided between at least one gate control line GCL and the light emitting device ED. When it is necessary to distinguish between the metal blocking layer 190a provided in the viewing angle control line unit VCLU and the metal blocking layer 190b provided in the gate control line unit GCLU, the metal blocking layer 190a provided in the viewing angle control line unit VCLU is referred to as a first metal blocking layer 190a, and the metal blocking layer 190b provided in the gate control line unit GCLU is referred to as a second metal blocking layer 190b.

For example, as illustrated in FIGS. 19 and 20, when a first gate control line GCL1 to which the first scan voltage SVGH is supplied and a second gate control line GCL2 to which the second scan voltage SVGL is supplied overlap one red first light emitting device RED1 and two red second light emitting devices RED2, parasitic capacitance can be generated between anodes configuring the light emitting devices RED1 and RED2 and the gate control lines GCL1 and GCL2.

Therefore, the metal blocking layer 190b can be provided between at least one gate control line GCL and the light emitting device ED in order to prevent parasitic capacitance.

For example, the metal blocking layer 190b can be a line connected to the cathode CA. In this case, the second voltage ELVSS can be supplied to the metal blocking layer 190b.

Parasitic capacitance may not be formed between the gate control lines GCL1 and GCL2 and the light emitting device ED by the metal blocking layer 190b to which the second voltage ELVSS is supplied.

Accordingly, in the light emitting device ED, light corresponding to the data voltage Vdata can be normally output.

The above-described metal blocking layer 190 (when the metal blocking layer 190a provided in the viewing angle control line unit VCLU and the metal blocking layer 190b provided in the gate control line unit GCLU are collectively referred to as metal blocking layer, reference numeral 190 can be used) can be provided in each of the viewing angle control line unit VCLU and the gate control line unit GCLU.

Moreover, the metal blocking layer 190 can be provided to overlap each of the light emitting devices provided in the viewing angle control line unit VCLU.

Also, the metal blocking layer 190 can be provided to overlap each of the light emitting devices provided in the gate control line unit GCLU.

The features of the light emitting display apparatus according to an embodiment of the present disclosure are briefly summarized as follows.

A light emitting display apparatus according to an embodiment of the present disclosure comprises a viewing angle control line unit including at least one viewing angle control line provided between a first unit pixel driving circuit and a second unit pixel driving circuit provided along a nth (n is a natural number) scan line and a gate control line unit including gate control lines provided between a kth (k is a natural number) unit pixel driving circuit and a k+1th unit pixel driving circuit provided along the nth scan line, wherein at least one unit pixel driving circuit is provided between the viewing angle control line unit and the gate control line unit adjacent to each other, the at least one viewing angle control line is connected to the first unit pixel driving circuit and the second unit pixel driving circuit, and the gate control lines are connected to a gate driver provided between the viewing angle control line unit and the gate control line unit.

The gate control lines are connected to a control driver which generates gate control signal to be supplied to the gate control lines, and the at least one viewing angle control line is connected to the control driver.

When one unit pixel driving circuit is provided between the viewing angle control line unit and the gate control line unit which are adjacent to each other, the kth unit pixel driving circuit is the second unit pixel driving circuit and the k+1th unit pixel driving circuit is a third unit pixel driving circuit.

Each of the first unit pixel driving circuit and the second unit pixel driving circuit includes at least three subpixel driving circuits, each of the at least three subpixel driving circuits includes a first viewing angle control transistor connected to a first viewing angle control line provided in the viewing angle control line unit and a second viewing angle control transistor connected to a second viewing angle control line provided in the viewing angle control line unit.

A first viewing angle of light output from a first light emitting unit driven by the first viewing angle control transistor and a second viewing angle of light output from a second light emitting unit driven by the second viewing angle control transistor are different.

The first viewing angle control transistor is connected between the first light emitting unit and a driving transistor which controls the level of the current supplied to the first light emitting unit or the second light emitting unit, and the second viewing angle control transistor is connected between the driving transistor and the second light emitting unit.

The at least one viewing angle control line is connected to unit pixel driving circuits adjacent along the at least one viewing angle control line.

The viewing angle control line unit further includes at least one auxiliary gate control line connected to the gate driver.

The viewing angle control line unit further includes branch circuits connected to the gate control lines.

The gate control line unit further includes branch circuits connected to the gate control lines.

Each of the first unit pixel driving circuit and the second unit pixel driving circuit includes at least three subpixel driving circuits, and the viewing angle control line unit overlaps any one of subpixel driving circuits provided in the first unit pixel driving circuit and the second unit pixel driving circuit.

The viewing angle control line unit further includes a metal blocking layer provided between the at least one viewing angle control line and the light emitting device.

Each of the kth unit pixel driving circuit and the k+1th unit pixel driving circuit includes at least three subpixel driving circuits, and the gate control line unit overlaps a light emitting device connected to any one of subpixel driving circuits provided in the kth unit pixel driving circuit and the k+1th unit pixel driving circuit.

The gate driver includes a scan driver connected to switching transistors provided in unit pixel driving circuits, the scan driver includes scan stages, among the scan stages, an nth scan stage connected to the nth scan line includes nth scan branch circuits, each of the nth scan branch circuits includes at least one transistor, and each of the nth scan branch circuits is provided in one of viewing angle control line units and gate control line units adjacent along the nth scan line.

The nth scan line and at least two scan lines adjacent to the nth scan line overlap each of the nth scan branch circuits configuring the nth scan stage.

Among the scan stages, a n+1th scan stage connected to a n+1th scan line includes n+1th scan branch circuits, each of the n+1th scan branch circuits includes at least one transistor, each of the n+1th scan branch circuits is provided in one of viewing angle control line units and gate control line units adjacent along the n+1th scan line, and at least one of at least three scan lines overlapping the nth scan branch circuits does not overlap the n+1th scan branch circuits.

Another scan stage configuring the scan driver is provided on a left side or a right side of the nth scan stage, along a first direction parallel to the nth scan line, and another scan stage configuring the scan driver is provided on an upper end or a lower end of the nth scan stage, along a second direction different from the first direction.

The gate driver includes a reference driver connected to reference transistors provided in the unit pixel driving circuits, the reference driver includes reference stages, among the reference stages, an nth reference stage connected to subpixels connected to the nth scan line includes nth reference branch circuits, each of the nth reference branch circuits includes at least one transistor, and each of the nth reference branch circuits is provided in one of viewing angle control line units and gate control line units adjacent along the nth scan line.

The nth scan line and at least two scan lines adjacent to the nth scan line overlap each of the nth reference branch circuits configuring the nth reference stage.

The reference driver is provided on a left side or a right side of the scan driver, along a first direction parallel to the nth scan line.

The light emitting display apparatus according to the present disclosure can be applied to all electronic devices including a light emitting display panel. For example, the light emitting display apparatus according to the present disclosure can be applied to a virtual reality (VR) device, an augmented reality (AR) device, a mobile device, a video phone, a smart watch, a watch phone, or a wearable device, device, foldable device, rollable device, bendable device, flexible device, curved device, electronic notebook, e-book, PMP (portable multimedia player), PDA (personal digital assistant), MP3 player, mobile medical device, desktop PC, laptop PC, netbook computer, workstation, navigation, car navigation, vehicle display devices, televisions, wall paper display devices, signage devices, game devices, laptops, monitors, cameras, camcorders, and home appliances.

According to the light emitting display apparatus according to an embodiment of the present disclosure, a viewing angle can be controlled in unit of at least two unit pixels. Accordingly, a user and a passenger can easily, quickly, and comfortably recognize an image they need through the light emitting display device.

According to the light emitting display apparatus according to an embodiment of the present disclosure, a gate driver can be provided in a display area. Accordingly, even if the left and right width of the light emitting display apparatus increases, a delay of a gate pulse in the specific area cannot occur. Accordingly, the quality of the light emitting display apparatus can be improved.

According to the light emitting display apparatus according to an embodiment of the present disclosure, a metal blocking layer can be provided between anodes and control lines for controlling a viewing angle or a gate driver and. Accordingly, a phenomenon in which anode voltages are affected by control signals supplied to the control lines can be reduced. Therefore, the quality of the light emitting display apparatus can be improved.

In the light emitting display apparatus according to an embodiment of the present disclosure, viewing angle control lines for controlling a viewing angle and gate control lines for controlling a gate driver can be provided alternately at certain intervals. Moreover, pixels can be provided in the same or similar form according to certain rules. Accordingly, the circuit design of the light emitting display apparatus can be simplified, and the quality of an image can be improved.

The above-described feature, structure, and effect of the present disclosure are included in at least one embodiment of the present disclosure, but are not limited to only one embodiment. Furthermore, the feature, structure, and effect described in at least one embodiment of the present disclosure may be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the present disclosure.

What is claimed is:

1. A light emitting display apparatus comprising:
a viewing angle control line unit including at least one viewing angle control line between a first unit pixel driving circuit and a second unit pixel driving circuit provided along a nth (n is a natural number) scan line; and
a gate control line unit including gate control lines provided between a kth (k is a natural number) unit pixel driving circuit and a k+1th unit pixel driving circuit provided along the nth scan line,
wherein at least one unit pixel driving circuit is between the viewing angle control line unit and the gate control line unit that are adjacent to each other,
the at least one viewing angle control line is connected to the first unit pixel driving circuit and the second unit pixel driving circuit, and the gate control lines are connected to a gate driver provided between the viewing angle control line unit and the gate control line unit.

2. The light emitting display apparatus of claim 1, wherein the gate control lines are connected to a control driver that generates a gate control signal supplied to the gate control lines, and the at least one viewing angle control line is connected to the control driver.

3. The light emitting display apparatus of claim 1, wherein while one unit pixel driving circuit is between the viewing angle control line unit and the gate control line unit which are adjacent to each other, the kth unit pixel driving circuit is the second unit pixel driving circuit and the k+1th unit pixel driving circuit is a third unit pixel driving circuit.

4. The light emitting display apparatus of claim 1, wherein each of the first unit pixel driving circuit and the second unit pixel driving circuit includes at least three subpixel driving circuits, each of the at least three subpixel driving circuits including:
a first viewing angle control transistor connected to a first viewing angle control line provided in the viewing angle control line unit; and
a second viewing angle control transistor connected to a second viewing angle control line provided in the viewing angle control line unit.

5. The light emitting display apparatus of claim 4, wherein a first viewing angle of light output from a first light emitting unit that is driven by the first viewing angle control transistor is different from a second viewing angle of light output from a second light emitting unit that is driven by the second viewing angle control transistor.

6. The light emitting display apparatus of claim 5, wherein the first viewing angle control transistor is connected between the first light emitting unit and a driving transistor that controls a level of a current supplied to the first light emitting unit or the second light emitting unit, and
the second viewing angle control transistor is connected between the driving transistor and the second light emitting unit.

7. The light emitting display apparatus of claim 1, wherein the at least one viewing angle control line is connected to unit pixel driving circuits that are adjacent along the at least one viewing angle control line.

8. The light emitting display apparatus of claim 1, wherein the viewing angle control line unit further includes at least one auxiliary gate control line connected to the gate driver.

9. The light emitting display apparatus of claim 1, wherein the viewing angle control line unit further includes branch circuits connected to the gate control lines.

10. The light emitting display apparatus of claim 1, wherein the gate control line unit further includes branch circuits connected to the gate control lines.

11. The light emitting display apparatus of claim 1, wherein each of the first unit pixel driving circuit and the second unit pixel driving circuit includes at least three subpixel driving circuits, and the viewing angle control line unit overlaps any one of subpixel driving circuits included in the first unit pixel driving circuit and the second unit pixel driving circuit.

12. The light emitting display apparatus of claim 11, wherein the viewing angle control line unit further includes a metal blocking layer between the at least one viewing angle control line and a light emitting device.

13. The light emitting display apparatus of claim 1, wherein each of the kth unit pixel driving circuit and the k+1th unit pixel driving circuit includes at least three subpixel driving circuits, and the gate control line unit overlaps a light emitting device connected to any one of subpixel driving circuits provided in the kth unit pixel driving circuit and the k+1th unit pixel driving circuit.

14. The light emitting display apparatus of claim 1, wherein the gate driver includes a scan driver connected to switching transistors provided in unit pixel driving circuits,
wherein the scan driver includes scan stages, and among the scan stages, an nth scan stage connected to the nth scan line includes nth scan branch circuits,
wherein each of the nth scan branch circuits includes at least one transistor, and each of the nth scan branch circuits is in one of viewing angle control line units and gate control line units adjacent along the nth scan line.

15. The light emitting display apparatus of claim 14, wherein the nth scan line and at least two scan lines adjacent to the nth scan line overlap each of the nth scan branch circuits configuring the nth scan stage.

16. The light emitting display apparatus of claim 14, wherein among the scan stages, a n+1th scan stage connected to a n+1th scan line includes n+1th scan branch circuits,
wherein each of the n+1th scan branch circuits includes at least one transistor and each of the n+1th scan branch circuits is in one of viewing angle control line units and gate control line units adjacent along the n+1th scan line, and
at least one of at least three scan lines overlapping the nth scan branch circuits is non-overlapping with the n+1th scan branch circuits.

17. The light emitting display apparatus of claim 14, wherein another scan stage configuring the scan driver is on a left side or a right side of the nth scan stage along a first direction parallel to the nth scan line, and another scan stage configuring the scan driver is on an upper end or a lower end of the nth scan stage along a second direction that is different from the first direction.

18. The light emitting display apparatus of claim 14, wherein the gate driver includes a reference driver connected to reference transistors in the unit pixel driving circuits, the reference driver including reference stages and among the reference stages, an nth reference stage connected to subpixels connected to the nth scan line includes nth reference branch circuits,
wherein each of the nth reference branch circuits includes at least one transistor, and each of the nth reference branch circuits is in one of viewing angle control line units and gate control line units adjacent along the nth scan line.

19. The light emitting display apparatus of claim 18, wherein the nth scan line and at least two scan lines adjacent to the nth scan line overlap each of the nth reference branch circuits configuring the nth reference stage.

20. The light emitting display apparatus of claim 18, wherein the reference driver is on a left side or a right side of the scan driver along a first direction parallel to the nth scan line.
